(19) United States
(12) Patent Application Publication
(10) Pub. No.: US 2025/0162614 A1
(43) Pub. Date: May 22, 2025

(54) SYSTEM AND METHOD FOR SAFE CONTROL SYNTHESIS FOR HYBRID SYSTEMS THROUGH LOCAL CONTROL BARRIER FUNCTIONS

(71) Applicant: Toyota Motor Engineering & Manufacturing North America, Inc., Plano, TX (US)

(72) Inventors: Shuo YANG, Philadelphia, PA (US); Georgios FAINEKOS, Novi, MI (US); Bardh HOXHA, Canton, MI (US); Mitchell BLACK, Plano, TX (US); Hideki OKAMOTO, Ann Arbor, MI (US); Danil V. PROKHOROV, Canton, MI (US); Hardik PARWANA, Ann Arbor, MI (US)

(73) Assignees: Toyota Motor Engineering & Manufacturing North America, Inc., Plano, TX (US); TOYOTA JIDOSHA KABUSHIKI KAISHA, Toyota-shi (JP)

(21) Appl. No.: 18/751,977

(22) Filed: Jun. 24, 2024

Related U.S. Application Data
(60) Provisional application No. 63/601,813, filed on Nov. 22, 2023.

(51) Int. Cl. B60W 60/00

(52) U.S. Cl. CPC B60W 60/0015; B60W 2520/10; B60W 2520/105; B60W 2552/40; B60W 2554/802

(57) ABSTRACT

A mode switch controller includes a memory having instructions stored therein; and a processor configured to execute the instructions stored in the memory to cause the mode switch controller to: instruct a hybrid mode controller to output a first mode control signal to cause a system to operate in a first mode; and instruct the hybrid mode controller, based on a detected parameter signal, a first control barrier function, and a second control barrier function, to output a second mode control signal to cause a system to operate in a second mode, wherein the first control barrier function is based on the system operating in the first mode and the system switching from operating in the first mode to operating in the second mode, and wherein the second control barrier function is based on the system operating in the second mode.

The present application claims priority from U.S. Provisional Application No. 63/601,813 filed Nov. 22, 2023, the entire disclosure of which is incorporated herein by reference.

### BACKGROUND

The present disclosure generally relates to systems and methods for controlling a hybrid mode autonomous system via local control barrier functions (CBFs).

### SUMMARY

An aspect of the present disclosure is drawn to a mode switch controller that includes a memory having instructions stored therein; and a processor configured to execute the instructions stored in the memory to cause the mode switch controller to: instruct a hybrid mode controller to output the first mode control signal to cause a system to operate in a first mode; and instruct the hybrid mode controller, based on a detected parameter signal, a first control barrier function, and a second control barrier function, to output a second mode control signal to cause the system to operate in a second mode, wherein the first control barrier function is based on the system operating in the first mode and the system switching from operating in the first mode to operating in the second mode, and wherein the second control barrier function is based on the system operating in the second mode.

In some embodiments of this aspect, the second control barrier function is based on the system operating in the second mode and the system switching from operating in the first mode to operating in the second mode.

In some embodiments of this aspect, the processor may be configured to execute the instructions stored in the memory to additionally cause the mode switch controller to determine, based on the detected parameter signal, the first control barrier function, and the second control barrier function, whether the system is to operate in the second mode to cause the system to guarantee safety to the system.

In some embodiments of this aspect, the processor may be configured to execute the instructions stored in the memory to additionally cause the mode switch controller to: determine, based on the detected parameter signal, whether the system is to operate in the second mode, wherein the detected parameter signal is based on the at least one of a group of parameters comprising velocity of the system, acceleration of the system, a distance of the system to a location, a distance of the system to an object, a condition of an environment for which the system is disposed, and a parameter of the system.

In some embodiments of this aspect, the processor may be configured to execute the instructions stored in the memory to additionally cause the mode switch controller to: determine, based on the detected parameter signal, whether the system is to operate in the second mode, wherein the detected parameter signal is based on a velocity of an autonomous vehicle. In some of these embodiments, the processor may be configured to execute the instructions stored in the memory to additionally cause the mode switch controller to determine, based on the detected parameter signal, the first control barrier function, and the second control barrier function, whether the system is to operate in the second mode to cause the system to guarantee safety to the autonomous vehicle.

In some embodiments of this aspect, the processor may be configured to execute the instructions stored in the memory to additionally cause the mode switch controller to: determine, based on the detected parameter signal, whether the system is to operate in the second mode, wherein the detected parameter signal is based on a condition of an environment for which an autonomous vehicle is disposed.

Another aspect of the present disclosure is drawn to a method including: instructing, via a processor configured to execute the instructions stored in a memory, a hybrid mode controller to output a first mode control signal to cause a system to operate in a first mode; and instructing, via the processor and based on a detected parameter signal, a first control barrier function, and a second control barrier function, the hybrid mode controller to output a second mode control signal to cause the system to operate in a second mode, wherein the first control barrier function is based on the system operating in the first mode and the system switching from operating in the first mode to operating in the second mode, and wherein the second control barrier function is based on the system operating in the second mode.

In some embodiments of this aspect, the second control barrier function is based on the system operating in the second mode and the system switching from operating in the first mode to operating in the second mode.

In some embodiments of this aspect, the method further includes determining, via the processor and based on the detected parameter signal, the first control barrier function, and the second control barrier function, whether the system is to operate in the second mode to cause the system to guarantee safety to the system.

In some embodiments of this aspect, the method further includes: determining, via the processor and based on the detected parameter signal, whether the system is to operate in the second mode, wherein the detected parameter signal is based on at least one of a group of parameters comprising velocity of the system, acceleration of the system, a distance of the system to a location, a distance of the system to an object, a condition of an environment for which the system is disposed, and a parameter of the system.

In some embodiments of this aspect, the method further includes: determining, via the processor and based on the detected parameter signal, whether the system is to operate in the second mode, wherein the detected parameter signal is based on a velocity of an autonomous vehicle. In some of these embodiments, the method further includes determining, via the processor and based on the detected parameter signal, the first control barrier function, and the second control barrier function, whether the system is to operate in the second mode to cause the system to guarantee safety to an autonomous vehicle.

In some embodiments of this aspect, the method further includes: determining, via the processor and based on the detected parameter signal, whether the system is to operate in the second mode, wherein the detected parameter signal is based on a condition of an environment for which an autonomous vehicle is disposed.

Another aspect of the present disclosure is drawn to a non-transitory, computer-readable media having computer-readable instructions stored thereon, the computer-readable instructions being capable of being read by a mode switch controller. The computer-readable instructions are capable of instructing the mode switch controller to perform the method including: instructing, via a processor configured to execute the instructions stored in a memory, of a mode switch controller having the processor and the memory, a hybrid mode controller to output a first mode control signal to cause a system to operate in a first mode; and instructing, via the processor and based on a detected parameter signal, a first control barrier function, and a second control barrier function, the hybrid mode controller to output a second mode control signal to cause the system to operate in a second mode, wherein the first control barrier function is based on the system operating in the first mode and the system switching from operating in the first mode to operating in the second mode, and wherein the second control barrier function is based on the system operating in the second mode.

In some embodiments of this aspect, the computer-readable instructions are capable of instructing the mode switch controller to perform the method wherein the second control barrier function is based on the system operating in the second mode and the system switching from operating in the first mode to operating in the second mode.

In some embodiments of this aspect, the computer-readable instructions are capable of instructing the mode switch controller to perform the method further including determining, via the processor and based on the detected parameter signal, the first control barrier function, and the second control barrier function, whether the system is to operate in the second mode to cause the system to guarantee safety to the system.

In some embodiments of this aspect, the computer-readable instructions are capable of instructing the mode switch controller to perform the method further including: determining, via the processor and based on the detected parameter signal, whether the system is to operate in the second mode, wherein the detected parameter signal is based on at least one of a group of parameters comprising velocity of the system, acceleration of the system, a distance of the system to a location, a distance of the system to an object, a condition of an environment for which the system is disposed, and a parameter of the system.

In some embodiments of this aspect, the computer-readable instructions are capable of instructing the mode switch controller to perform the method further including: determining, via the processor and based on the detected parameter signal, whether the system is to operate in the second mode, wherein the detected parameter signal is based on a velocity of an autonomous vehicle.

In some embodiments of this aspect, the computer-readable instructions are capable of instructing the mode switch controller to perform the method further including determining, via the processor and based on the detected parameter signal, the first control barrier function, and the second control barrier function, whether the system is to operate in the second mode to cause the system to guarantee safety to the autonomous vehicle.

### BRIEF SUMMARY OF THE DRAWINGS

The accompanying drawings, which are incorporated in and form a part of the specification, illustrate and explain examples. In the drawings:

FIG. 1 illustrates two vehicles driving on a road;

FIG. 2 illustrates a graph of a trajectory of the autonomous vehicle of FIG. 1;

FIG. 3 illustrates an array of safe/unsafe states of a hybrid mode autonomous system using a related art global CBF approach;

FIG. 4 illustrates a graph of a trajectory of the autonomous vehicle of FIG. 1 using a related art global CBF approach;

FIG. 5A illustrates an array of safe/unsafe states of a first mode in a hybrid mode autonomous system using a related art local CBF approach;

FIG. 5B illustrates an array of safe/unsafe states of a second mode in the hybrid mode autonomous system of FIG. 5A;

FIG. 5C illustrates an array of safe/unsafe states, and additional unsafe states, of the hybrid mode autonomous system of FIG. 5A, after switching from operating in the first mode of operation;

FIG. 6 illustrates a graph of a trajectory of the autonomous vehicle of FIG. 1 using a related art local CBF approach;

FIG. 7A illustrates an array of safe/unsafe states of a first mode in a hybrid mode autonomous system using a local CBF approach in accordance with aspects of the present disclosure;

FIG. 7B illustrates an array of safe/unsafe states of a second mode in the hybrid mode autonomous system of FIG. 7A;

FIG. 8 illustrates a graph of a trajectory of the autonomous vehicle of FIG. 1 using a local CBF approach in accordance with aspects of the present disclosure;

FIG. 9 illustrates a hybrid system model for a hybrid system of an autonomous vehicle of FIG. 1;

FIG. 10 illustrates an example hybrid automaton;

FIG. 11 illustrates a Dubins car collision avoidance example;

FIG. 12A illustrates an example hybrid mode autonomous system in accordance with aspects of the present disclosure at a time to;

FIG. 12B illustrates the hybrid mode autonomous system of FIG. 12A at a time ti;

FIG. 13 illustrates an example method of operating a mode switch controller of the hybrid mode autonomous system of FIG. 12A in accordance with aspects of the present disclosure;

FIG. 14A illustrates a more detailed view of the mode switch controller of the hybrid mode autonomous system of FIG. 12A; and

FIG. 14B illustrates the mode switch controller of the hybrid mode autonomous system of FIG. 12B.

### DETAILED DESCRIPTION

Safety-critical control is one of the fundamental problems in autonomous systems. Among various safety control methods, control synthesis methods utilizing CBFs is a recent active area of research.

CBFs are powerful tools in the world of control theory, which is all about designing systems that behave in a desired way. Specifically, CBFs help ensure safety, meaning they prevent the system from entering unsafe states.

For example, imagine a safe region for an autonomous system—like a robot staying within a designated area; a drone avoiding obstacles; an autonomous anesthesia provider maintaining a safe blood pressure of a patient during surgery; an autonomous turbine generator maintaining a safe operating temperature; etc. The CBF is a function that acts like a wall around this safe region. As the system gets closer to the boundary, the value of the function increases rapidly. Think of it like an alarm bell getting louder the closer a person may approach the edge of a cliff. The controller, which guides the system, uses the CBF to choose safe control inputs. If a control input would make the CBF increase, the controller knows it is taking the system towards danger and chooses a different option.

CBF can explicitly encode safe sets and enforce the invariance of safe sets via solving efficient online quadratic programs (QP). QPs are optimization problems where the objective function and constraints are all quadratic expressions. QPs are often used in control to find optimal control inputs subject to various constraints.

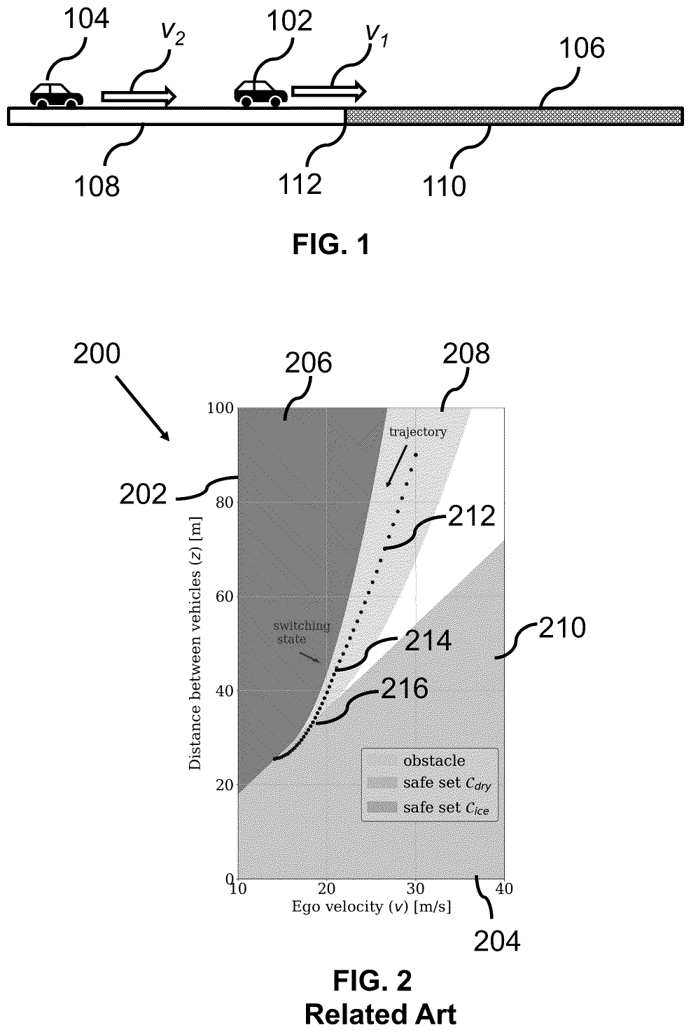

A special class of autonomous systems is the class of hybrid dynamical systems, which involves both continuous dynamic flow and discrete dynamical mode jumps for state evolution. Such discrete mode transitions could be needed to model physical phenomena, or high-level logical decision making. For instance, vehicle dynamics switching from dry road to wet road could be modeled by a hybrid system. Bipedal robot walking is another example of a hybrid system. Safety concerns naturally arise for safety-critical hybrid systems and many safety approaches have been proposed in the past, such as Hamilton-Jacobi reachability-based approaches and computing controlled invariant sets. This will be described in greater detail with reference to FIGS. 1A and 2.

FIG. 1 illustrates a lead vehicle 102 being followed by an autonomous vehicle 104, each of which are driving on a road 106. Road 106 includes a dry surface portion 108 and an icy surface portion 110. Icy surface portion 110 starts at a position 112 from autonomous vehicle 104.

As discussed herein, the idea is to create a control system that will enable autonomous vehicle 104 to safely follow lead vehicle 102, while driving on dry surface portion 108 and icy surface portion 110.

FIG. 2 illustrates a graph 200 of a trajectory of autonomous vehicle 104 of FIG. 1.

Graph 200 includes a y-axis 202, an x-axis 204, a shaded area 206, a shaded area 208, a shaded area 210 and a plotted trajectory 212. Y-axis 202 corresponds to the distance between lead vehicle 102 and autonomous vehicle 104 and is measured in units of meters. X-axis 204 corresponds to the velocity of autonomous vehicle 104 and is measured in units of meters/second.

Shaded area 206 corresponds to safe states for autonomous vehicle 104 to drive on icy surface portion 110 of road 106. For example, if driving on icy surface portion 110 of road 106 behind lead vehicle 102, if autonomous vehicle 104 is 80 meters behind lead vehicle 102 (at the 80 mark on y-axis 202) and is driving at 20 m/s (at the 20 mark on x-axis 204), then autonomous vehicle 104 is driving in a safe state, e.g., autonomous vehicle 104 is unlikely to collide with lead vehicle 102 in the event that lead vehicle 102 abruptly stops.

Shaded area 208 corresponds to safe states for autonomous vehicle 104 to drive on dry surface portion 108 of road 106. For example, if driving on dry surface portion 108 of road 106 behind lead vehicle 102, if autonomous vehicle 104 is 80 meters behind lead vehicle 102 (at the 80 mark on y-axis 202) and is driving at 30 m/s (at the 30 mark on x-axis 204), then autonomous vehicle 104 is driving in a safe state, e.g., autonomous vehicle 104 is unlikely to collide with lead vehicle 102 in the event that lead vehicle 102 abruptly stops.

Shaded area 210 corresponds to unsafe states for autonomous vehicle 104 to drive on road 106. For example, if driving on road 106 behind lead vehicle 102, if autonomous vehicle 104 is 40 meters behind lead vehicle 102 (at the 40 mark on y-axis 202) and is driving at 30 m/s (at the 30 mark on x-axis 204), then autonomous vehicle 104 is not driving in a safe state, e.g., autonomous vehicle 104 is likely to collide with lead vehicle 102 in the event that lead vehicle 102 abruptly stops.

Trajectory 212 illustrates the distance between autonomous vehicle 104 and lead vehicle 102 as a function of velocity of autonomous vehicle 104 over a plurality of samples. In this example, autonomous vehicle 104 starts out on dry surface portion 108 of road 106, separated from lead vehicle 102 by 90 meters and is traveling at an initial velocity of 30 m/s. In this example, lead vehicle 102 starts slowing down for some reason.

To maintain safety, e.g., avoiding colliding with lead vehicle 102, autonomous vehicle 104 must respond to the decrease in velocity of lead vehicle 102. In this case, autonomous vehicle 104 slows down. However, the rate of a decrease in velocity of autonomous vehicle 104 is managed by incrementally detecting the distance to lead vehicle 102 and determining whether autonomous vehicle 104 is driving on dry surface portion 108 of road 106 or icy surface portion 110 of road 106. In particular, as shown in graph 200, autonomous vehicle 104 needs to maintain different driving states to maintain safety, depending on whether autonomous vehicle 104 is driving on dry surface portion 108 of road 106 (shaded area 208) or icy surface portion 110 of road 106 (shaded area 206). However, the decrease is velocity of autonomous vehicle over time, the distance between autonomous vehicle 104 and lead vehicle 102 decreases.

In this example, autonomous vehicle 104 switches modes of operation at point 214 of trajectory 212, wherein the velocity of autonomous vehicle 104 is 22 m/s and the distance of autonomous vehicle 104 from lead vehicle 102 is 45 meters. As shown in the figure, although autonomous vehicle 104 switches modes of operation in an attempt to maintain safety, the trajectory of autonomous vehicle 104 drifts into an unsafe state as indicated by the portion 216 of trajectory 212 within shaded area 210.

CBF-based approaches have been used to ensure safety for hybrid systems recently for its computational efficiency, in which use a global CBF (i.e., all dynamical modes share a common CBF) to ensure safety. However, such a global notion is restrictive and less necessary since it requires the CBF to satisfy the same invariance conditions for all dynamical modes, which results in the challenge of constructing a valid global CBF, and also in more conservative control behavior.

Safety is a paramount concern in hybrid systems and various methods for safety verification and control synthesis have been proposed. Among them, barrier function-based methods can provide provable safety guarantees. Furthermore, CBFs emerged as a principled control method to enforce safety for controlled hybrid systems. Some related art systems define a global CBF for hybrid systems and propose a data-driven constructive method to find a valid global CBF.

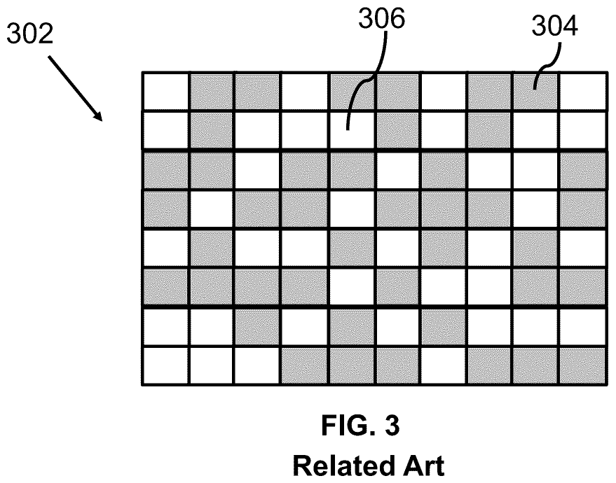

FIG. 3 illustrates an array 302 of safe/unsafe states of a hybrid mode autonomous system using a related art global CBF approach.

As shown in the figure, array 302 is an array of individual cells, wherein each cell represents a particular global state of operation of at least one subsystem in the hybrid mode autonomous system.

It should be noted that described herein, an autonomous system refers to any machine or system capable of operating independently and making decisions without direct human input. They often utilize advanced capabilities like: sensors gathering information about the environment; algorithms processing data and making decisions based on pre-programmed rules or machine learning; actuators taking physical actions based on those decisions. Non-limiting examples of such autonomous systems include: robots performing tasks in factories, hospitals, or hazardous environments; self-driving cars navigating roads and making decisions based on traffic and surroundings; drones carrying out deliveries or surveillance missions; smart thermostats automatically adjusting temperature based on occupancy and energy efficiency; cybersecurity systems detecting and responding to threats without human intervention.

The level of autonomy can vary considerably, with some systems requiring occasional human oversight while others operate almost entirely independently. The defining characteristic remains their ability to function without constant direct instructions.

Hybrid mode means that the autonomous system is configured to operate in at least two different modes of operation. For purposes of simplifying the discussion herein, the example above with reference to FIG. 1 will be used, wherein the hybrid mode autonomous system has two modes of operation, a dry surface mode to be performed while driving on dry surface portion 108 and an icy surface mode to be performed while driving on icy surface portion 110.

It should be noted that in some cases, a hybrid mode autonomous system may not be an independent system. For example, a vehicle may not by itself be a hybrid mode autonomous system, particularly a vehicle that is operated by a person. However, a person-operated vehicle may include a hybrid mode autonomous system therein, such as for example a cruise control system that autonomously controls the velocity of the vehicle.

It should be further noted that a hybrid mode autonomous system may include a plurality of subsystems. For example, an autonomous vehicle may have a steering subsystem, a breaking subsystem, an environment detection subsystem, etc., wherein each subsystem may operate within predetermined parameters based on a mode of operation.

For purposes of discussion, let the hybrid mode autonomous system correspond to autonomous vehicle 104 operating with a related art global CBF approach. Each cell in array 302 represents a distinct state of autonomous vehicle 104. In other words, each cell represents a distinct mode of operation for all autonomous subsystems of autonomous vehicle 104, e.g., the predetermined maximum velocity, the minimum following distance to lead vehicle 102, the sampling times for environment detection systems, etc.

In this manner, a global state may include a safe state, wherein at least one subsystem of autonomous vehicle is configured to operate in a predetermined manner such that autonomous vehicle 104 may safely follow lead vehicle 102, e.g., autonomous vehicle 104 is unlikely to collide with lead vehicle 102 in the event that lead vehicle 102 abruptly stops.

As shown in the figure, array 302 includes a plurality of darkened safe states, a sample of which is indicated as safe state 304. These safe states represent possible modes of operation for all autonomous subsystems of autonomous vehicle 104 that will enable autonomous vehicle 104 to safely follow lead vehicle 102.

Similarly, a global state may include an unsafe state, wherein autonomous vehicle 104 may not safely follow lead vehicle 102, e.g., autonomous vehicle 104 is likely to collide with lead vehicle 102 in the event that lead vehicle 102 abruptly stops.

As shown in the figure, array 302 includes a plurality of white unsafe states, a sample of which is indicated as unsafe state 306. These unsafe states represent possible modes of operation for all autonomous subsystems of autonomous vehicle 104 that will cause autonomous vehicle 104 to not safely follow lead vehicle 102.

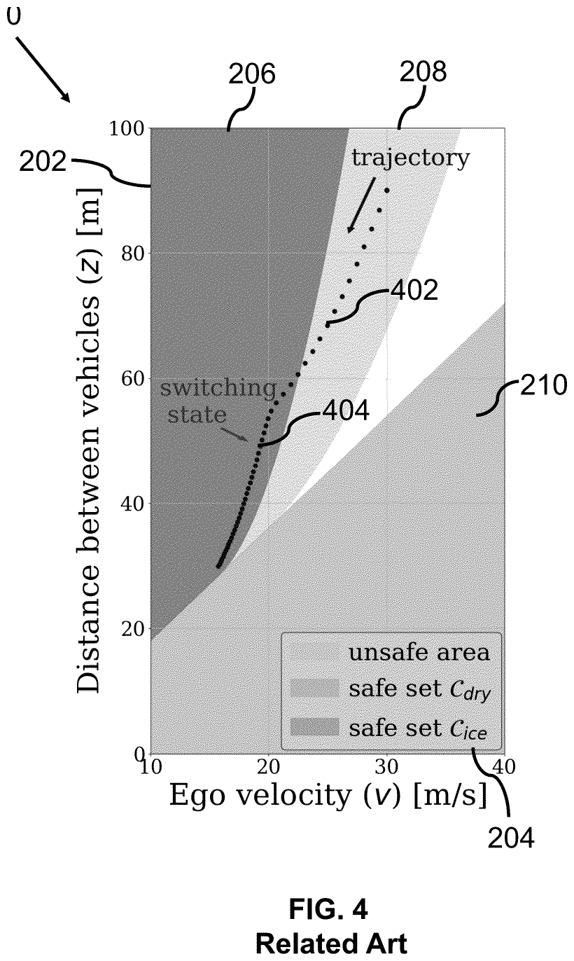

FIG. 4 illustrates a graph 400 of a trajectory of autonomous vehicle 104 of FIG. 1 using a related art global CBF approach.

Graph 400 includes y-axis 202, x-axis 204, shaded area 206, shaded area 208, shaded area 210 and a plotted trajectory 402.

Trajectory 402 illustrates the distance between autonomous vehicle 104 and lead vehicle 102 as a function of velocity of autonomous vehicle 104 over a plurality of samples. In this example, autonomous vehicle 104 starts out on dry surface portion 108 of road 106, separated from lead vehicle 102 by 90 meters and is traveling at an initial velocity of 30 m/s. In this example, lead vehicle 102 starts slowing down for some reason.

To maintain safety, e.g., avoiding colliding with lead vehicle 102, autonomous vehicle 104 must respond to the decrease in velocity of lead vehicle 102. In this case, autonomous vehicle 104 slows down. However, the rate of a decrease in velocity of autonomous vehicle 104 is managed by incrementally detecting the distance to lead vehicle 102 and determining whether autonomous vehicle 104 is driving on dry surface portion 108 of road 106 or icy surface portion 110 of road 106. In particular, as shown in graph 400, autonomous vehicle 104 needs to maintain different driving states to maintain safety, depending on whether autonomous vehicle 104 is driving on dry surface portion 108 of road 106 (shaded area 208) or icy surface portion 110 of road 106 (shaded area 206). However, the decrease is velocity of autonomous vehicle over time, the distance between autonomous vehicle 104 and lead vehicle 102 decreases.

In this example, autonomous vehicle 104 switches modes of operation at a point 404 of trajectory 402, wherein the velocity of autonomous vehicle 104 is 19 m/s and the distance of autonomous vehicle 104 from lead vehicle 102 is 50 meters. As shown in the figure, autonomous vehicle 104 switches modes of operation to maintain safety, wherein the trajectory of autonomous vehicle 104 does not drift into an unsafe state within shaded area 210.

While a global CBF method of operating a hybrid mode autonomous system may maintain safety, as mentioned above such a global notion is restrictive and less necessary since it requires the CBF to satisfy the same invariance conditions for all dynamical modes, which results in the challenge of constructing a valid global CBF.

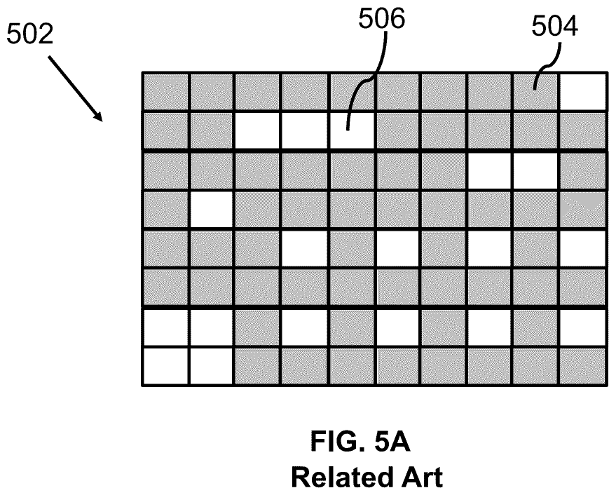

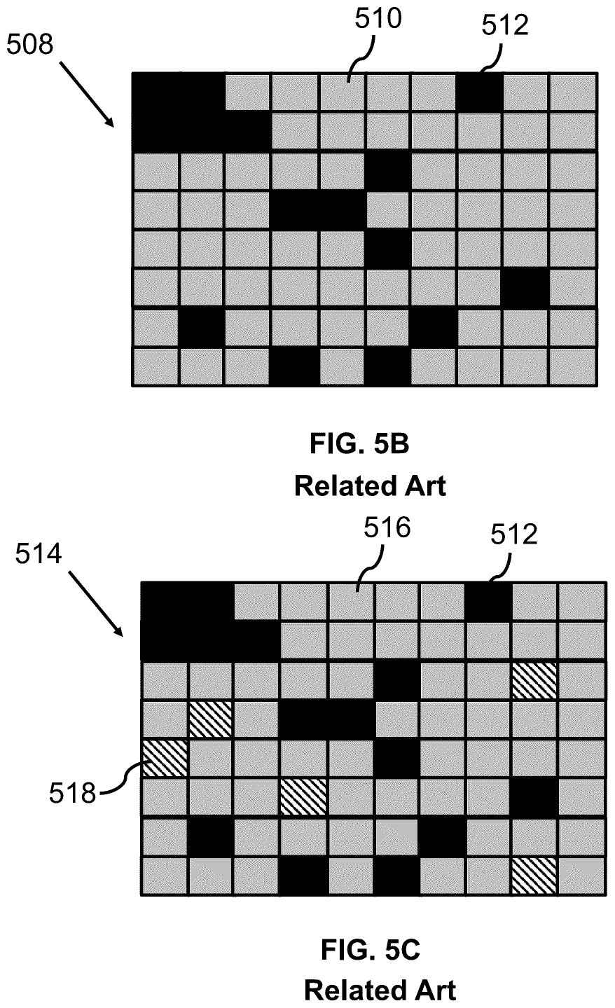

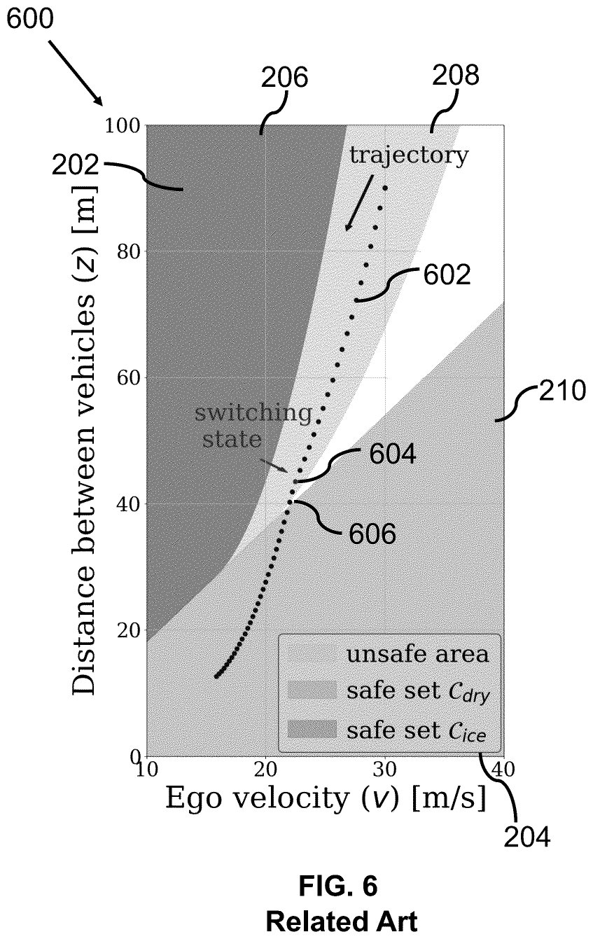

As opposed to a global CBF method as discussed above with reference to FIGS. 3 and 4, a local CBF method may be used. This will be described in greater detail with reference to FIGS. 5A-6.

FIG. 5A illustrates an array 502 of safe/unsafe states of a first mode in a hybrid mode autonomous system using a related art local CBF approach.

For purposes of discussion, let the hybrid mode autonomous system correspond to autonomous vehicle 104 operating with a related art local CBF approach. Each cell in array 502 represents a distinct state of autonomous vehicle 104, while operating in a dry surface mode, i.e., while driving on dry surface portion 108. In other words, each cell represents a distinct mode of operation for all autonomous subsystems of autonomous vehicle 104, e.g., the predetermined maximum velocity, the minimum following distance to lead vehicle 102, the sampling times for environment detection systems, etc., while driving on dry surface portion 108.

In this manner, in a safe local state, at least one subsystem of autonomous vehicle is configured to operate in a predetermined manner such that autonomous vehicle 104 may safely follow lead vehicle 102, e.g., autonomous vehicle 104 is unlikely to collide with lead vehicle 102 in the event that lead vehicle 102 abruptly stops, while operating in the dry surface mode.

As shown in the figure, array 502 includes a plurality of darkened safe states, a sample of which is indicated as safe state 504. These safe states represent possible modes of operation for all autonomous subsystems of autonomous vehicle 104 that will enable autonomous vehicle 104 to safely follow lead vehicle 102, while operating in the dry surface mode.

Similarly, in an unsafe local state, wherein autonomous vehicle 104 may not safely follow lead vehicle 102, e.g., autonomous vehicle 104 is likely to collide with lead vehicle 102 in the event that lead vehicle 102 abruptly stops, while operating in the dry surface mode.

As shown in the figure, array 502 includes a plurality of white unsafe states, a sample of which is indicated as unsafe state 506. These unsafe states represent possible modes of operation for all autonomous subsystems of autonomous vehicle 104 that will cause autonomous vehicle 104 to not safely follow lead vehicle 102, while operating in the dry surface mode.

FIG. 5B illustrates an array 508 of safe/unsafe states of a second mode in the hybrid mode autonomous system of FIG. 5A.

Each cell in array 508 represents a distinct state of autonomous vehicle 104, while operating in an icy surface mode, i.e., while driving on icy surface portion 110. In other words, each cell represents a distinct mode of operation for all autonomous subsystems of autonomous vehicle 104, e.g., the predetermined maximum velocity, the minimum following distance to lead vehicle 102, the sampling times for environment detection systems, etc., while driving on icy surface portion 110.

In this manner, in a safe local state, at least one subsystem of autonomous vehicle is configured to operate in a predetermined manner such that autonomous vehicle 104 may safely follow lead vehicle 102, e.g., autonomous vehicle 104 is unlikely to collide with lead vehicle 102 in the event that lead vehicle 102 abruptly stops, while operating in the icy surface mode.

As shown in the figure, array 508 includes a plurality of darkened safe states, a sample of which is indicated as safe state 510. These safe states represent possible modes of operation for all autonomous subsystems of autonomous vehicle 104 that will enable autonomous vehicle 104 to safely follow lead vehicle 102, while operating in the icy surface mode.

Similarly, in an unsafe local state, wherein autonomous vehicle 104 may not safely follow lead vehicle 102, e.g., autonomous vehicle 104 is likely to collide with lead vehicle 102 in the event that lead vehicle 102 abruptly stops, while operating in the icy surface mode.

As shown in the figure, array 508 includes a plurality of black unsafe states, a sample of which is indicated as unsafe state 512. These unsafe states represent possible modes of operation for all autonomous subsystems of autonomous vehicle 104 that will cause autonomous vehicle 104 to not safely follow lead vehicle 102, while operating in the icy surface mode.

A problem with the related art local CBF method of controlling a hybrid mode autonomous system is that a switching from one mode of operation to another affects the safety conditions. This will be described in greater detail with reference to FIG. 5C.

FIG. 5C illustrates an array 514 of safe/unsafe states, and additional unsafe states, of a second mode of operation of the hybrid mode autonomous system of FIG. 5A, after switching from operating in the first mode of operation.

Each cell in array 508 represents a distinct state of autonomous vehicle 104, while operating in an icy surface mode, after having operated in the dry surface mode and switching to the icy surface mode. In other words, autonomous vehicle 104 had operated in the dry surface mode, while driving on dry surface portion 108, then switched to operate in the icy surface mode when it started driving on icy surface portion 110. In other words, each cell represents a distinct mode of operation for all autonomous subsystems of autonomous vehicle 104, e.g., the predetermined maximum velocity, the minimum following distance to lead vehicle 102, the sampling times for environment detection systems, etc., while driving on icy surface portion 110 after driving on the dry surface portion 108.

In this manner, in a safe local state, at least one subsystem of autonomous vehicle is configured to operate in a predetermined manner such that autonomous vehicle 104 may safely follow lead vehicle 102, e.g., autonomous vehicle 104 is unlikely to collide with lead vehicle 102 in the event that lead vehicle 102 abruptly stops, while operating in the icy surface mode after driving on the dry surface portion 108.

As shown in the figure, array 514 includes a plurality of darkened safe states, a sample of which is indicated as safe state 516. These safe states represent possible modes of operation for all autonomous subsystems of autonomous vehicle 104 that will enable autonomous vehicle 104 to safely follow lead vehicle 102, while operating in the icy surface mode after driving on the dry surface portion 108.

Similarly, in an unsafe local state, wherein autonomous vehicle 104 may not safely follow lead vehicle 102, e.g., autonomous vehicle 104 is likely to collide with lead vehicle 102 in the event that lead vehicle 102 abruptly stops, while operating in the icy surface mode after driving on the dry surface portion 108.

As shown in the figure, array 514 includes the same plurality of black unsafe states, the sample of which is indicated as unsafe state 512, that are include in array 508 discussed above with reference to FIG. 5B. These unsafe states represent possible modes of operation for all autonomous subsystems of autonomous vehicle 104 that will cause autonomous vehicle 104 to not safely follow lead vehicle 102, while operating in the icy surface mode after driving on the dry surface portion 108.

However, the act of switching between modes affects the level of safety when operating the second mode, which in this case in the icy surface mode. This is reflected in the additional plurality of striped unsafe states, a sample of which is indicated as unsafe state 518. These additional unsafe states represent possible modes of operation for all autonomous subsystems of autonomous vehicle 104 that will cause autonomous vehicle 104 to not safely follow lead vehicle 102, while operating in the icy surface mode after driving on the dry surface portion 108, and because of switching from the dry surface mode to the icy surface mode.

Unfortunately, the related art local CBF method of controlling a hybrid mode autonomous system does not account for these additional unsafe states discussed with reference to FIG. 5C. This will be described in greater detail with reference to FIG. 6.

FIG. 6 illustrates a graph 600 of a plotted trajectory 602 of autonomous vehicle 104 of FIG. 1 using a related art local CBF approach.

Graph 600 includes y-axis 202, x-axis 204, shaded area 206, shaded area 208, shaded area 210 and plotted trajectory 602.

Trajectory 602 illustrates the distance between autonomous vehicle 104 and lead vehicle 102 as a function of velocity of autonomous vehicle 104 over a period of samples. In this example, autonomous vehicle 104 starts out on dry surface portion 108 of road 106, separated from lead vehicle 102 by 90 meters and is traveling at an initial velocity of 30 m/s. In this example, lead vehicle 102 starts slowing down for some reason.

To maintain safety, e.g., avoiding colliding with lead vehicle 102, autonomous vehicle 104 must respond to the decrease in velocity of lead vehicle 102. In this case, autonomous vehicle 104 slows down. However, the rate of a decrease in velocity of autonomous vehicle 104 is managed by incrementally detecting the distance to lead vehicle 102 and determining whether autonomous vehicle 104 is driving on dry surface portion 108 of road 106 or icy surface portion 110 of road 106. In particular, as shown in graph 600, autonomous vehicle 104 needs to maintain different driving states to maintain safety, depending on whether autonomous vehicle 104 is driving on dry surface portion 108 of road 106 (shaded area 208) or icy surface portion 110 of road 106 (shaded area 206). However, the decrease is velocity of autonomous vehicle over time, the distance between autonomous vehicle 104 and lead vehicle 102 decreases.

In this example, autonomous vehicle 104 switches modes of operation at point 604 of trajectory 602, wherein the velocity of autonomous vehicle 104 is 22 m/s and the distance of autonomous vehicle 104 from lead vehicle 102 is 45 meters. As shown in the figure, although autonomous vehicle 104 switches modes of operation in an attempt to maintain safety, the trajectory of autonomous vehicle 104 drifts into an unsafe state as indicated by the portion 606 of trajectory 602 within shaded area 210.

What is needed is a system and method for controlling a hybrid mode autonomous system that uses local CBFs and that accounts for switching between modes of operation.

A system and method in accordance with aspects of the present disclosure enables the control of a hybrid mode autonomous system using local CBFs and accounts for switching between modes of operation.

To mitigate the drawbacks of a global CBF approach, a system and method in accordance with aspects of the present disclosure uses multiple local CBFs to guarantee global safety. In accordance with aspects of the present disclosure, each dynamical mode is presumed to have its own local CBF, which implies that each mode can be safe under CBF-based control without considering discrete mode switching. However, it is possible that some unsafe behaviors can occur under discrete transitions (jumps) even if all modes can be safe independently. To ensure global safety of hybrid systems, those safe and unsafe switching regions are first identified. Then, the initial local CBFs are refined by considering safety after mode switching. Finally, safety of hybrid systems is guaranteed under refined local CBFs.

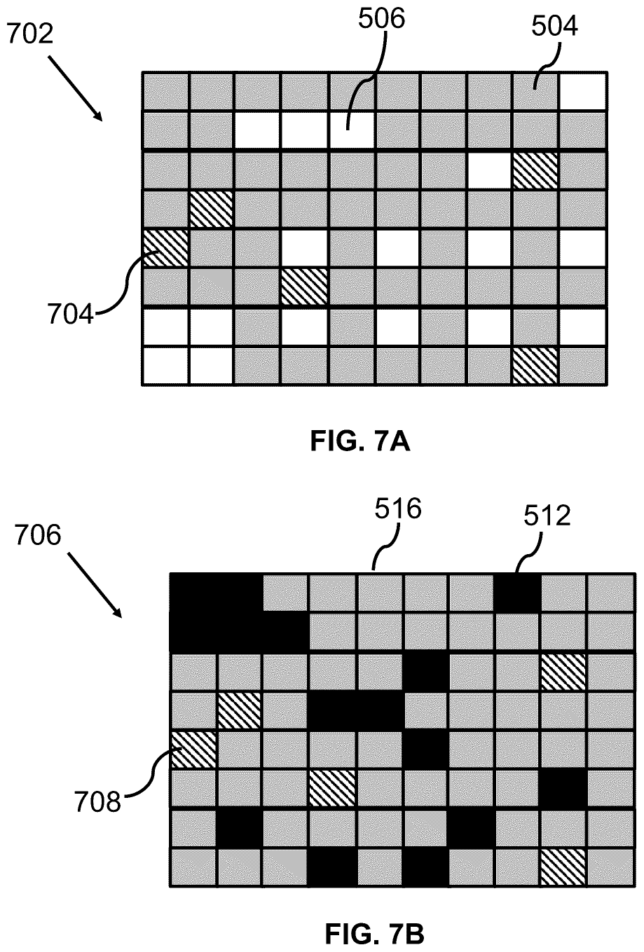

A system and method for control of a hybrid mode autonomous system using local CBFs and accounting for switching between modes of operation in accordance with aspects of the present disclosure will now be described in greater detail with reference to FIGS. 7A-13.

FIG. 7A illustrates an array 702 of safe/unsafe states of a first mode in a hybrid mode autonomous system using a local CBF approach in accordance with aspects of the present disclosure.

For purposes of discussion, let the hybrid mode autonomous system correspond to autonomous vehicle 104 operating with a local CBF approach in accordance with aspects of the present disclosure. Each cell in array 702 represents a distinct state of autonomous vehicle 104, while operating in a dry surface mode, i.e., while driving on dry surface portion 108. In other words, each cell represents a distinct mode of operation for all autonomous subsystems of autonomous vehicle 104, e.g., the predetermined maximum velocity, the minimum following distance to lead vehicle 102, the sampling times for environment detection systems, etc., while driving on dry surface portion 108.

In this manner, in a safe local state, at least one subsystem of autonomous vehicle is configured to operate in a predetermined manner such that autonomous vehicle 104 may safely follow lead vehicle 102, e.g., autonomous vehicle 104 is unlikely to collide with lead vehicle 102 in the event that lead vehicle 102 abruptly stops, while operating in the dry surface mode.

As shown in the figure, array 702 includes the plurality of darkened safe states (the sample of which is indicated as safe state 504) that are included in array 502 discussed above with reference to FIG. 5A. These safe states represent possible modes of operation for all autonomous subsystems of autonomous vehicle 104 that will enable autonomous vehicle 104 to safely follow lead vehicle 102, while operating in the dry surface mode.

Similarly, in an unsafe local state, wherein autonomous vehicle 104 may not safely follow lead vehicle 102, e.g., autonomous vehicle 104 is likely to collide with lead vehicle 102 in the event that lead vehicle 102 abruptly stops, while operating in the dry surface mode.

As shown in the figure, array 702 includes the plurality of white unsafe states (the sample of which is indicated as unsafe state 506) that are included in array 502 discussed above with reference to FIG. 5A. These unsafe states represent possible modes of operation for all autonomous subsystems of autonomous vehicle 104 that will cause autonomous vehicle 104 to not safely follow lead vehicle 102, while operating in the dry surface mode.

However, there may be some “safe” states in the dry surface mode, that when autonomous vehicle 104 transitions to the icy surface mode, will ultimately be unsafe. As such, these otherwise safe states will be determined to be unsafe in accordance with aspects of the present disclosure.

As shown in the figure, array 702 includes a plurality of striped unsafe states, a sample of which is indicated as an unsafe state 704. These unsafe states represent possible modes of operation for all autonomous subsystems of autonomous vehicle 104 that will cause autonomous vehicle 104 to not safely follow lead vehicle 102, while operating in the dry surface mode, but will later switch to the icy surface mode.

FIG. 7B illustrates an array 706 of safe/unsafe states of a second mode in the hybrid mode autonomous system of FIG. 7A, after switching from operating in the first mode of operation.

Each cell in array 706 represents a distinct state of autonomous vehicle 104, while operating in an icy surface mode, after having operated in the dry surface mode and switching to the icy surface mode. In other words, autonomous vehicle 104 had operated in the dry surface mode, while driving on dry surface portion 108, then switched to operate in the icy surface mode when it started driving on icy surface portion 110. Therefore, each cell represents a distinct mode of operation for all autonomous subsystems of autonomous vehicle 104, e.g., the predetermined maximum velocity, the minimum following distance to lead vehicle 102, the sampling times for environment detection systems, etc., while driving on icy surface portion 110 after driving on the dry surface portion 108.

In this manner, in a safe local state, at least one subsystem of autonomous vehicle is configured to operate in a predetermined manner such that autonomous vehicle 104 may safely follow lead vehicle 102, e.g., autonomous vehicle 104 is unlikely to collide with lead vehicle 102 in the event that lead vehicle 102 abruptly stops, while operating in the icy surface mode after driving on the dry surface portion 108.

As shown in the figure, array 706 includes the plurality of darkened safe states (the sample of which is indicated as safe state 516) that are included in array 514. These safe states represent possible modes of operation for all autonomous subsystems of autonomous vehicle 104 that will enable autonomous vehicle 104 to safely follow lead vehicle 102, while operating in the icy surface mode after driving on the dry surface portion 108.

Similarly, in an unsafe local state, wherein autonomous vehicle 104 may not safely follow lead vehicle 102, e.g., autonomous vehicle 104 is likely to collide with lead vehicle 102 in the event that lead vehicle 102 abruptly stops, while operating in the icy surface mode after driving on the dry surface portion 108.

As shown in the figure, array 514 includes the same plurality of black unsafe states, the sample of which is indicated as unsafe state 512, that are include in array 508 discussed above with reference to FIG. 5B. These unsafe states represent possible modes of operation for all autonomous subsystems of autonomous vehicle 104 that will cause autonomous vehicle 104 to not safely follow lead vehicle 102, while operating in the icy surface mode after driving on the dry surface portion 108.

However, the act of switching between modes affects the level of safety when operating the second mode, which in this case in the icy surface mode. This is reflected in the additional plurality of striped unsafe states, a sample of which is indicated as unsafe state 708. These additional unsafe states represent possible modes of operation for all autonomous subsystems of autonomous vehicle 104 that will cause autonomous vehicle 104 to not safely follow lead vehicle 102, while operating in the icy surface mode after driving on the dry surface portion 108, and because of switching from the dry surface mode to the icy surface mode.

As compared to the related art local CBF method discussed above with reference to FIGS. 5A-C, in accordance with aspects of the present disclosure, some states in the first mode of operation, that otherwise would have been considered safe, are determined to be unsafe as a result of an impending switch to the second mode of operation. Further, in accordance with aspects of the present disclosure, some states in the second mode of operation, that otherwise would have been considered safe, are determined to be unsafe as a result of switching to the second mode of operation.

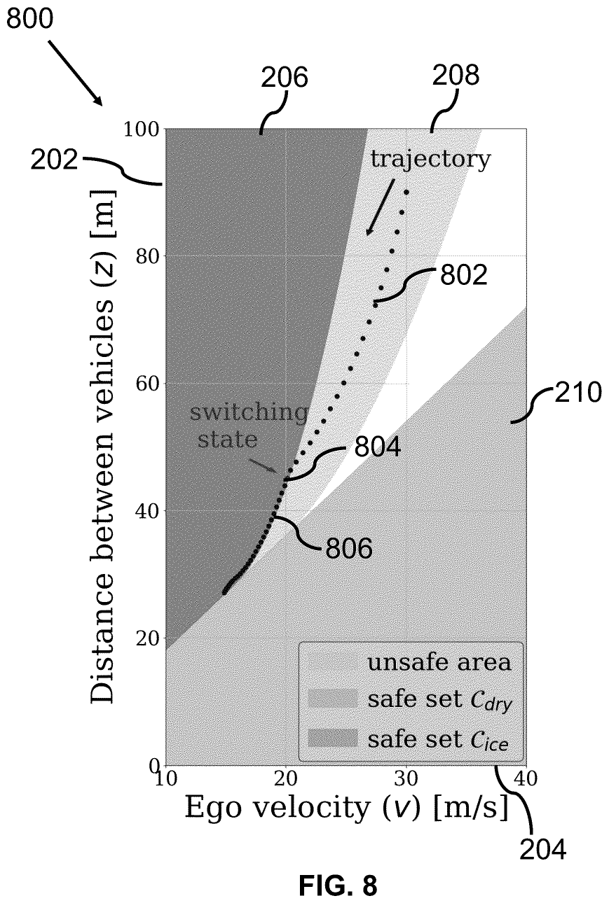

The end result of the safe switching from one mode to another in accordance with aspects of the present disclosure will be further explained with reference to FIG. 8.

FIG. 8 illustrates a graph 800 of a trajectory of autonomous vehicle 104 of FIG. 1 using a local CBF approach in accordance with aspects of the present disclosure.

Graph 800 includes y-axis 202, x-axis 204, shaded area 206, shaded area 208, shaded area 210 and a plotted trajectory 802.

Trajectory 802 illustrates the distance between autonomous vehicle 104 and lead vehicle 102 as a function of velocity of autonomous vehicle 104 over a plurality of samples. In this example, autonomous vehicle 104 starts out on dry surface portion 108 of road 106, separated from lead vehicle 102 by 90 meters and is traveling at an initial velocity of 30 m/s. In this example, lead vehicle 102 starts slowing down for some reason.

To maintain safety, e.g., avoiding colliding with lead vehicle 102, autonomous vehicle 104 must respond to the decrease in velocity of lead vehicle 102. In this case, autonomous vehicle 104 slows down. However, the rate of a decrease in velocity of autonomous vehicle 104 is managed by incrementally detecting the distance to lead vehicle 102 and determining whether autonomous vehicle 104 is driving on dry surface portion 108 of road 106 or icy surface portion 110 of road 106. In particular, as shown in graph 800, autonomous vehicle 104 needs to maintain different driving states to maintain safety, depending on whether autonomous vehicle 104 is driving on dry surface portion 108 of road 106 (shaded area 208) or icy surface portion 110 of road 106 (shaded area 206). However, the decrease is velocity of autonomous vehicle over time, the distance between autonomous vehicle 104 and lead vehicle 102 decreases.

In this example, autonomous vehicle 104 switches modes of operation at a point 804 of trajectory 802, wherein the velocity of autonomous vehicle 104 is 18 m/s and the distance of autonomous vehicle 104 from lead vehicle 102 is 50 meters. As shown in the figure, autonomous vehicle 104 switches modes of operation to maintain safety, as evidenced by the trajectory of autonomous vehicle 104 not drifting into an unsafe state as indicated by shaded area 210.

A system and method in accordance with aspects of the present disclosure that employs refined local CBFs is also relevant to the Lyapunov-based stability for hybrid systems. In the realm of dynamical systems, stability is a crucial concept, and Lyapunov stability is a powerful tool for analyzing it. Imagine a ball rolling down a hill, a satellite orbiting a planet, or the temperature of a building changing over time. These are all examples of dynamical systems, where some state (e.g., the ball's position, the satellite's orbit, the building's temperature) evolves over time according to certain rules. In these systems, stability describes how the state behaves around a specific point of interest, often an equilibrium point (e.g., the ball at the bottom of the hill, the satellite's stable orbit). With respect to Lyapunov stability, if the state stays “close enough” to the equilibrium point when starting “close enough” initially, the system is Lyapunov stable. Think of the ball resting at the bottom of the hill—small pushes will not send it rolling far away. Traditionally, analyzing stability involves solving differential equations governing the system, which can be complex and challenging. Lyapunov's theory offers an alternative approach. It uses a special function called a Lyapunov function, which encodes the stability properties of the system. It has been demonstrated that unconstrained switching might lead to global instability even if all dynamical modes are stable with corresponding local Lyapunov functions. Thus, finding switching conditions for which global Lyapunov stability is guaranteed is one of the most important and elusive problems in the hybrid systems literature, and many approaches have been proposed. As a dual notion, safety is also of great importance in hybrid systems, but its related research is rather limited.

In accordance with aspects of the present disclosure, it is revealed that some switching conditions might lead to lack of global safety even if all dynamical modes are safe through control. A system and method in accordance with aspects of the present disclosure include an algorithmic procedure to ensure global safety using multiple local CBFs.

As disclosed herein, [symbol] and [symbol] ⁿ are the set of real numbers and real n-dimensional vectors, respectively. The set [symbol] denotes the natural numbers (including zero). Subscripts are used to denote subsets of these sets, e.g., [symbol] >0 denotes the set of positive real numbers.

Given a set X, [symbol] (X) denotes its powerset. Let α: [symbol] → [symbol] denote an extended class K_{∞} function, i.e., a strictly increasing function with α(0)=0.

Consider a continuous-time control-affine system:

$$\dot{x} = f ( x ) + g ( x ) u , x ( 0 ) = {x}_{0} , \qquad ( 1 )$$

where f and g are locally Lipschitz, x∈D⊆ [symbol] ⁿ is the state and D denotes a compact set in [symbol] ⁿ. Safety can be framed in the context of enforcing set invariance in the state space, i.e., the state should not exit a safe set [symbol] , The safe set [symbol] is represented by the super-level set of a continuously differentiable function h: D→ [symbol] . The algebraic expressions for the safe [symbol] set and its boundary ∂ [symbol] are given by:

$$𝒞 = \{ x ∈ D ⊂ {ℝ}^{n} : h ( x ) \geq 0 \} , \qquad ( 2 )$$

$$\partial 𝒞 = \{ x ∈ D ⊂ {ℝ}^{n} : h ( x ) = 0 \} , \qquad ( 3 )$$

For a locally Lipschitz continuous control law u=k(x), \dot{x}=f(x)+g(x)k(x) is locally Lipschitz continuous. Thus, for any initial condition x₀∈D, there exists a maximum time interval of existence I(x₀)=[0, τₘₐₓ), such that x(t) is the unique solution to the continuous-time control-affine system (1) on I(x₀). The safety of continuous-time control-affine system (1) is framed in terms of set invariance as will be discussed in greater detail below.

Definition 1 (Forward invariance and safety): The set [symbol] is forward invariant if for every x₀∈ [symbol] , x(t)∈ [symbol] holds for all t∈I(x₀). If C is forward invariant, it is said that the continuous-time control-affine system (1) is safe.

Herein, let every instance of “the system” or “a system” be a continuous-time control-affine system (1), unless otherwise explicitly indicated.

For forward invariance, it means that once the continuous-time control-affine system (1) enters a set [symbol] , it can never leave it, like a one-way door. The safe set [symbol] is a specific region in the system's state space in which it is desired to keep the system within. It represents the “safe zone.” The initial state x₀ is the starting point of the system, where it begins its journey within the state space. State x(t) represents the system's state at any given time t. The time interval of existence I(x₀) is the time window for which the system's behavior is defined and guaranteed. If forward invariance holds for a set [symbol] , it can be confidently said that the system is safe, meaning it will always stay within the boundaries of [symbol] and avoid any unsafe states. In simple terms, imagine a fenced-in area [symbol] where a pet is to be kept. Definition 1 ensures that if the pet starts inside the fence (x₀ within [symbol] can never escape (x(t) remains within [symbol] ) as long as the pet is being watched (within the time interval I(x₀)). If this holds true, it can be said that the pet is safe within the fenced area.

To verify invariance of [symbol] , a CBF can be used as a certificate which characterizes the admissible set of control inputs that render [symbol] forward invariant.

Definition 2 (CBF): Let [symbol] ⊂D⊂ [symbol] ⁿ be the superlevel set of a continuously differentiable function h: D→ [symbol] , then h is a CBF for safe set [symbol] if there exists an extended class [symbol] _{∞} function α(·) such that for the continuous-time control-affine system (1):

$${sup}_{u ∈ U} [ \frac{\partial h ( x )}{\partial x} ( f ( x ) + g ( x ) u ) ] \geq - α ( h ( x ) ) , \qquad ( 4 )$$

for all x∈D.

The CBF is a special function that acts as a “safety certificate” for the set [symbol] The CBF helps ensure that the system stays within [symbol] by guiding the control inputs. The superlevel set is the set of all points x in D for which h(x) is greater than or equal to a certain value. It is similar to the “hilly terrain” above a certain altitude on a map. The continuously differentiable function h is the mathematical function that defines the shape of the CBF. The continuously differentiable function h is like the “elevation map” that tells how high the terrain is at each point. The extended class K_{∞} function α(·) is a specific type of function that ensures the CBF has certain properties needed for safety guarantees. It is like a “ruler” that measures how steep the CBF is. The inequality condition ensures that the CBF always “pushes” the system back towards the safe set [symbol] , preventing it from crossing the boundary. It is like having a force field that repels the system from danger.

In simpler terms, imagine a hilly landscape (the CBF) surrounding a safe valley ( [symbol] ). The inequality condition ensures that no matter where a person starts (x) or how they move (u), they will always be pushed uphill (towards safety) if they get too close to the edge of the valley. This guarantees that they will never accidentally roll down into the dangerous lowlands outside the safe zone.

Given the CBF h(x), the set of all control values that render [symbol] safe is given by:

$${K}_{cbf} ( x ) = \{ u ∈ U : \frac{\partial h ( x )}{\partial x} [ f ( x ) + g ( x ) u ] + α ( h ( x ) ) > 0 \} \qquad ( 5 )$$

which is denoted as the safe control set. The following theorem shows that the existence of a CBF implies that the control system (1) is safe.

Theorem 1: Assume h(x) is a CBF on D⊃ [symbol] and

$$\frac{\partial h}{\partial x} ( x ) \neq 0$$

for all x∈ [symbol] . Then any Lipschitz continuous controller u(x) such that u(x)∈K_{cbf}(x) for all x∈∂ [symbol] will render the set [symbol] forward invariant.

The domain D⊃ [symbol] means that the CBF is defined over a region D that includes the safe set [symbol] , ensuring its protective influence within the safe zone. The gradient

$$\frac{\partial h}{\partial x} ( x ) \neq 0$$

for all x∈∂ [symbol] , condition guarantees that the CBF has a non-zero slope at the boundary of the safe set, creating a clear “slope” that guides the system back towards safety if it approaches the edge. The Lipschitz continuous controller u(x) can smoothly adjust the system's behavior without sudden jumps or discontinuities, helping to maintain stability and safety. The safe control set K_{cbf}(x) is the set of control inputs that are guaranteed to keep the system within the safe set [symbol] , acting as the “safe steering wheel” for the controller.

Theorem 1 provides a recipe for ensuring safety in a system using a CBF. A suitable CBF that defines the safe set is determined. A controller that always chooses safe control inputs is designed, wherein the system will then stay within the safe set indefinitely.

A hybrid automaton is a model of a system with both a continuous dynamic flow and discrete dynamic jumps. The state of a hybrid automaton is a pair (q, x) where q is the discrete mode and x is the continuous state vector.

Definition 3: A hybrid input automaton H_{I} is a tuple H_{I}= [symbol] X, Q, U, U_{q}, F, Guard [symbol] : where X⊆ [symbol] ⁿ is the continuous state space; Q is the finite set of modes; U⊆ [symbol] ^{m} denotes the continuous space of inputs, and U_{q}⊆U is the admissible control input set for each mode q∈Q; F: Q×X×U_{q}→X is a vector field that describes the real-time dynamic flow of the continuous state x, wherein for a mode q∈Q, F is defined as a control affine system

with admissible control set U_{q}:

$$\dot{x} = {F}_{q} ( x , u ) = {f}_{q} ( x ) + {g}_{q} ( x ) u ; and \qquad ( 6 )$$

Guard: Q×Q→ [symbol] (X) denotes the guard set that triggers mode switching.

In some embodiments, deterministic systems are considered, wherein there is no uncertainty in both the dynamic flow and discrete jumps. It should be noted that Definition 3 does not allow jumps in the value of the continuous state of the system. That is, there is an assumption that the continuous state component of a hybrid system solution is continuous with respect to time.

The hybrid input automaton is a mathematical model that captures the behavior of systems that exhibit both continuous dynamics (like a car moving) and discrete jumps (like a traffic light changing). It is like a blueprint for systems that can switch between different modes of operation. The continuous state space (X) represents all possible values that the system's continuous variables (like position, velocity, temperature) can take. It is like the “map” of all possible states the system can be in. The modes (Q) are distinct operating modes of the system, each with its own dynamics and control rules. It's like the different “gears” or “settings” that the system can switch between. The input space (U) represents all possible control inputs that can be applied to the system. It is like the “steering wheel” and “pedals” that are used to control the system's behavior. The admissible control input set (U_{q}) is the subset of control inputs that are allowed in a particular mode q. It is like the “rules of the road” that govern what can be done in each gear. The vector field (F) describes how the continuous state x evolves over time, depending on the current mode and control input. It is like the “engine” that drives the system's continuous dynamics. The guard set (Guard) defines the conditions under which the system can switch from one mode to another. It is like the “traffic lights” that tell the system when to change gears.

To provide execution semantics for the hybrid automaton, a switching feedback control law is defined.

Definition 4: a switching feedback control law is defined as k: Q×X→U, where k_{q}(x) is locally Lipshitz continuous with respect to x for any mode q.

The switching feedback control law is a control strategy that adapts to the current mode of the hybrid system and the current state of the system. It is like a “smart controller” that can change its behavior based on the situation. The function k takes the current mode (q) and the current state (x) as inputs and returns the appropriate control input (u) to apply. The function k is the “brain” of the controller that decides what to do. Being locally Lipschitz continuous is a technical condition that ensures that the control input does not change too abruptly as the state evolves, preventing sudden jumps or instability. It is like having a “smoothness” constraint on the controller's decisions. In simpler terms, imagine a driver who adjusts their driving style based on whether they are on a highway or a city street, and also based on the current traffic conditions. The switching feedback control law models this adaptive behavior, ensuring appropriate actions are taken in each situation. The “locally Lipschitz” part means the driver will not suddenly slam on the brakes or make erratic maneuvers, even if the traffic changes quickly.

The composition (∥) of a switching feedback controller k_{q} with a hybrid input automaton H_{I} will be referred to herein as a hybrid system. A hybrid system will be denoted by H=H_{I}∥k.

Definition 5: (Hybrid system solution): For a hybrid system H and a set of initial conditions Q₀×X₀⊆Q×X, a solution (trajectory) of H is a sequence (qᵢ, φᵢ, δᵢ)_{i∈N}, where N is [symbol] or a bounded subset of [symbol] , qᵢ∈Q represents the discrete mode, φᵢ: X× [symbol] _{≥0}→X represents the continuous state evolution, and δᵢ∈ [symbol] _{≥0}∪{∞} represents the duration of operating in mode I (i.e., dwell time), such that:
1) (q₀, x₀)∈Q₀×X₀ is the initial state of the hybrid system at time τ₀=0.
2) If there is some j∈N such that τⱼ=∞, then j=max N<∞, i.e., N is finite and j is unique.
3) For i∈N, we let

$${τ}_{i + 1} = {\sum }_{j = 0}^{i} {δ}_{i} .$$

If τᵢ<∞ for i>0, then τᵢ is the switching time from mode qᵢ₋₁ to qᵢ.
4) For all i∈N and for t∈[τᵢ, τᵢ₊₁], φᵢ(xᵢ, t) is the solution of (5) for mode qᵢ and initial condition xᵢ=φᵢ₋₁(xᵢ₋₁, τᵢ), unless i=0 since x₀ is defined. When τᵢ₊₁=∞, then t ranges over [τᵢ, τᵢ₊₁).
5) For all i∈N with i>0, if τᵢ<x₀, then

$${φ}_{i - 1} ( {τ}_{i} ) ∈ Guard ( {q}_{i - 1} , {q}_{i} ) .$$

The above conditions require that a mode transition happens when the continuous state belongs to the Guard set. Then the system follows the continuous flow of the new mode until the next mode transition occurs.

The hybrid system solution (trajectory) is a complete description of how a hybrid system evolves over time, capturing both its continuous dynamics and discrete mode changes. It is like a “roadmap” of the system's behavior. The sequence (qᵢ, φᵢ, δᵢ)_{i∈N} records the system's mode, continuous state, and duration of each mode at different points in time. It is like a “travel diary” that tracks the system's journey. The discrete mode qᵢ indicates which mode of operation the system is in at the i-th step of the trajectory. It is like the “gear” the system is currently in. The continuous state evolution φᵢ describes how the continuous state x changes over time within mode i. It is like the “engine” that drives the system's continuous dynamics within each gear. The duration δᵢ represents how long the system stays in mode i before switching to another mode. It is like the “mileage” covered in each gear before shifting.

In simpler terms, imagine a car that can drive on both roads and off-road terrain, and that can also switch between manual and automatic transmission. A solution (trajectory) of this hybrid system would describe the exact sequence of road types, transmission modes, speeds, and gear shifts that the car experiences during a particular trip. It would capture both the continuous changes in position and speed, as well as the discrete changes in road type and transmission mode.

The set containing all solutions of H with initial conditions Q₀×X₀ will be denoted by [symbol] _{H}(Q₀, X₀). If (Q₀, X₀)=(Q, X), i.e., any initial condition is possible, then [symbol] _{H} is written for the language. The notation q→q′ is used to represent the transition (q, q′) when Guard(q, q′)≠0.

It should be noted that in Definition 5, no conditions are explicitly imposed on the input signal u. However, condition 4 of Definition 5 requires that a solution to equation 5 exists. In addition, condition 4 of Definition 5 enforces continuity of the continuous state vector at discrete mode transition times, i.e., φᵢ₊₁(xᵢ₊₁, τᵢ₊₁)=xᵢ₊₁=φᵢ(xᵢ, τᵢ₊₁). Therefore, in the following, the solution of the hybrid system can be viewed as a function of time, i.e., x: [symbol] _{≥0}→X, and the jump index, i, and the hybrid mode q can be ignored when they are not important.

For purposes of discussion, a system and method in accordance with aspects of the present disclosure will be described with respect to the application of concern about the safety of a hybrid system as discussed above with reference to Definition 3. Before a problem statement is formulated, consider the following illustrative example.

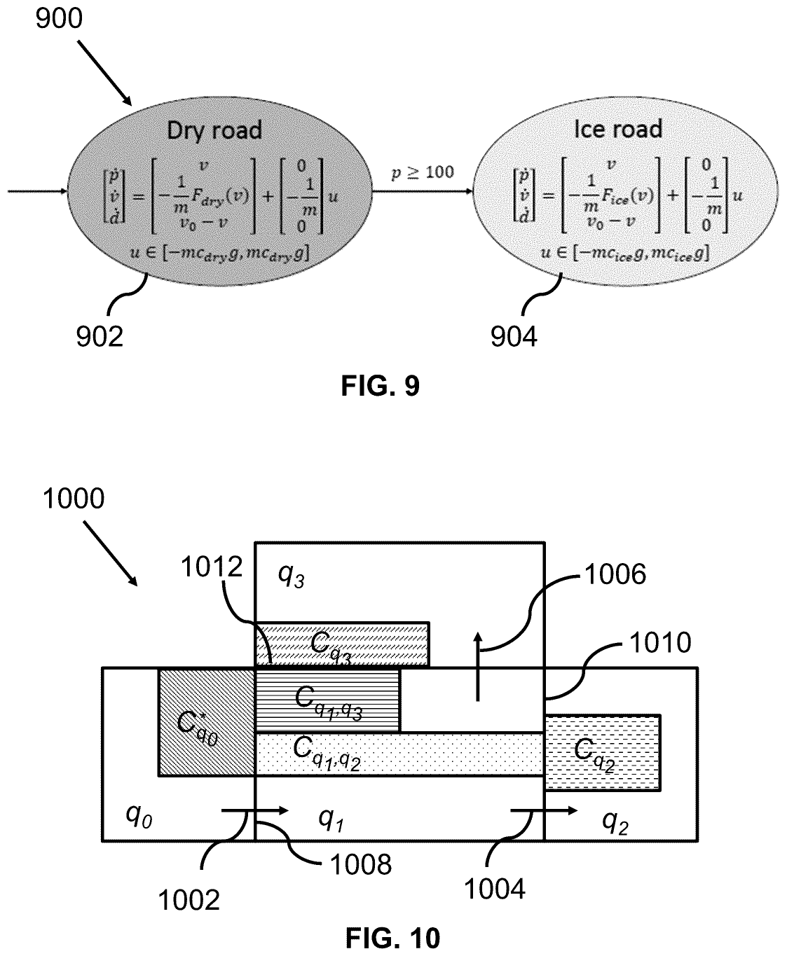

Consider an adaptive cruise control system. As shown in FIG. 1, let autonomous vehicle 104 be required to follow lead vehicle 102 and maintain a safe distance. As mentioned, road 106 is partitioned into dry surface portion 108 and ice road with different frictions and control input bounds. So there are two modes of dynamics in this example. This will be described in greater detail with reference to FIG. 9.

FIG. 9 illustrates a hybrid system model 900 for a hybrid system of autonomous vehicle 104. As shown in the figure, hybrid system model 900 includes a dry road mode of operation represented as a matrix transformation 902 and an ice road mode of operation represented as a matrix transformation 904.

The guard set Guard for the transition from “dry road” to “ice road” contains all states whose position p of the autonomous vehicle 104 is greater than 100 m. Intuitively, autonomous vehicle 104 should avoid high speed while switching from dry surface portion 108 to icy surface portion 110, since both the friction and control bound of the dynamics of icy surface portion 110 are smaller so autonomous vehicle 104 might not be able to decrease the speed as fast as in dry surface portion 108. Unsafe behavior can occur after switching from dry surface portion 108 to icy surface portion 110 even if autonomous vehicle 104 was safe on dry surface portion 108. This implies that having two CBFs, one for the dynamics of dry surface portion 108 and one for the dynamics of icy surface portion 110, and applying them as safety filters is not sufficient for global safety guarantees. Therefore, in accordance with aspects of the present disclosure, the safety of autonomous vehicle 104 is considered when switching dynamics.

First, a (q, q′)-safety for hybrid systems is defined, and then global safety is defined.

Definition 6 ((q, q′)-safety for hybrid systems: For a hybrid system H, a pair of modes (q, q′)∈Q², and safe sets C_{q}, C_{q′}⊂D for modes q and q′, respectively, it is said that H is (q, q′)-safe with respect to C_{q} and C_{q′} if for any initial state (q₀, x₀) with q₀=q and x₀∈C_{q}, the (potentially bounded) resulting trajectory

$$\begin{matrix}( {q}_{i} , {φ}_{i} , {δ}_{i} ) \\ \text{?}\end{matrix}$$

$$\text{?} \text{indicates text missing or illegible when filed}$$

of H with q₁=q′ satisfies:
φ₀(x₀, t)∈ [symbol] _{q} for all t∈[τ₀, τ₁], and
φ₁(x₁, t)∈ [symbol] _{q′} for all t∈[τ₁, τ₂] if δ₁<∞ or for all t≥τ₁ otherwise.

The (q, q′)-safety is a property that ensures the system stays within designated safe sets when transitioning from mode q to mode q′. For example, it makes sure the system does not enter dangerous areas during a specific gear shift.

The safe sets (C_{q}, C_{q′}) are regions in the continuous state space x that are considered safe for the system to operate in within modes q and q′, respectively. For example, they are like the “safe zones” for each gear.

The trajectory conditions are the three conditions listed in Definition 6, and enforce that: the system only switches from q to q′ at appropriate times (r); the continuous state remains within the safe sets for both modes before and after the switch; and the switch occurs only when the state reaches the guard set, ensuring proper transition conditions.

In simpler terms, imagine a car that needs to maintain a safe distance from other cars while on the highway, and also needs to stay within a certain speed limit in a school zone. The (q, q′)-safety would ensure that the car transitions smoothly between highway mode and school zone mode without violating these safety constraints. It would guarantee that the car does not get too close to other vehicles during the transition and that it slows down appropriately when entering the school zone.

The (q, q′)-safety definition discussed above enforces safety requirements for any trajectory transitioning from mode q to q′. Note that the safe set C_{q} for flow mode q and C_{q′} for q′ will be different, in general. Nevertheless, for (q, q′)-safety to hold (to be enforceable), it must be the case that [symbol] _{q}∩ [symbol] _{q′}∩Guard(q, q′)≠∅.

The set of possible mode transition pairs of a hybrid system H is defined as:

$$𝒯 ( H ) = \{ {( {q}_{i} , {q}_{i + 1} )}_{i ∈ N ∖ sup N} \vert {( {q}_{i} , {φ}_{i} , {δ}_{i} )}_{i ∈ N} ∈ {ℒ}_{H} \} \qquad ( 7 )$$

The global safety can now be defined based on (q, q′)-safety.

Definition 7 (Global safety for hybrid system): For a hybrid system H, for a given safe set C_{q}⊂D for any mode q∈Q, it is said that H is globally safe with respect to { [symbol] _{q}}_{q∈Q} if H is (q, q′)-safe for any (q, q′)∈ [symbol] (H).

Global safety is a more comprehensive safety property that ensures the system remains within safe sets for all possible mode transitions, not just specific pairs. It is like guaranteeing safety for all possible gear shifts, no matter the sequence. The safe sets (C_{q}) are the same safe regions defined in Definition 6, but now considered for all modes in the system. The (q, q′)-safety concept from Definition 6 is now applied to all possible mode transitions, ensuring safety for any possible combination of mode changes. The set of possible mode transition pairs [symbol] (H)set captures all the allowed transitions between modes in the hybrid system.

In simpler terms, imagine a car that has multiple driving modes (city, highway, off-road, etc.) and can switch between them based on road conditions and driver preferences. Global safety would ensure that the car always stays within safe speed limits, maintains safe distances from other cars, and avoids dangerous maneuvers, regardless of the sequence of mode transitions it makes. It would provide a comprehensive safety guarantee for any possible driving scenario.

Similar to (q, q′)-safety, [symbol] _{q}∩ [symbol] _{q}′∩Guard(q, q′)≠∅ must also hold for any (q, q′)∈ [symbol] (H) to ensure that global safety is enforceable. As discussed in more detail below, it is assumed that the safe sets for each mode of the hybrid automaton are provided since the goal is to synthesize a switching controller that guarantees global safety.

Assumption 1: For any mode q∈Q of H_{I}, it is assumed that there exists a local control barrier function h_{q} for Definition 5 and the corresponding safe set [symbol] _{q}={x∈D⊂ [symbol] ⁿ: h_{q}(x)≥0}. For every q∈Q, the safe control set is denoted by:

$${K}_{q} ( x ) = \{ u ∈ {U}_{q} : \frac{\partial {h}_{q} ( x )}{\partial x} [ {f}_{q} ( x ) + {g}_{q} ( x ) u ] \geq - {α}_{q} ( {h}_{q} ( x ) ) \} , \qquad ( 8 )$$

where α_{q} is the corresponding extended class K_{∞} function.

Assumption 1 says that every mode of the hybrid automaton is equipped with its own local CBF. This is a mild assumption given the growing literature on the synthesis of CBFs. However, local CBFs cannot guarantee safety when switching between different modes. In other words, applying a control input u∈K_{q} when the mode is q is not enough to ensure safety when the autonomous system switches to a mode q′. As such, in accordance with aspects of the present disclosure, the following problem is formulated.

Problem 1: Given a hybrid automaton H_{I}, under Assumption 1 discussed above, two sub-problems are to be solved: 1) find a switching control law k that can ensure the (q, q′)-safety of H, where q, q′∈Q; and 2) find a switching control law k that can ensure the

global safety of H.

To solve Problem 1, safe and unsafe switching sets are first identified, and then the unsafe backward reachable set is computed. Finally, the initial local CBFs are refined by avoiding the new unsafe sets. The refined CBFs can guarantee safety for the hybrid system.

The notions of safety for hybrid dynamical systems will now be formalized, and sufficient conditions for safe control synthesis will be provided. To start, what is safe and unsafe switching sets will be defined.

Definition 8 (Save and unsafe switching sets): For any mode jump q→q′ in H, the corresponding safe switching set is defined by S_{q,q′}=Guard(q, q′)∩ [symbol] _{q}∩ [symbol] _{q′} and the corresponding unsafe switching set is defined by U_{q,q′}=(Guard(q, q′)∩ [symbol] _{q})\S_{q,q′}.

The safe switching set (S_{q,q′}) is the set of states within the guard set Guard(q, q′) that are also within the safe set Cq for mode q. It is the “safe zone” for switching from mode q to mode q′.

The unsafe switching set (U_{q,q′}) is the set of states within the guard set that are not within the safe set C_{q}. In other words, it is the “danger zone” for switching, where safety might be compromised. The Guard set (Guard(q, q′)) is the set of states that trigger the transition from mode q to mode q′. For example, this is the “checkpoint” where the system decides to change gears.

The safe set (C_{q}) is the region in the state space that is considered safe for mode q. It is the “safe operating zone” for that particular gear.

In simpler terms, imagine a car that needs to slow down to a certain speed before entering a sharp curve. The safe switching set would be the set of speeds that are both within the safe speed limit for the current road and also slow enough to safely make the curve. The unsafe switching set would be the set of speeds that are too high for the curve, even if they're technically within the speed limit for the current road. The guard set would be the point on the road where the car needs to make the decision to slow down or not.

Safety can be preserved when the switching state is in the safe switching set S_{q,q′}. However, safety is jeopardized when the switching state is in the unsafe switching set. This intuition is formalized below.

Proposition 1: For a hybrid system H and a given initial condition (q₀, x₀), for any (potentially bounded) trajectory (qᵢ, φᵢ, δᵢ)_{i∈{0,1}} of H that satisfies q₀=q and q₁=q′, the following is provided:
if φ₀(x₀, t)∈ [symbol] _{q} for all t∈[τ₀, τ₁], and φ₀(x₀, τ₁)∈S_{q,q′}, then φ₁(x₁, t)∈ [symbol] _{q′} under k_{q′}(φ₁(x₁, t))∈K_{q′}(φ₁(x₁, t)) for all t∈[τ₁, τ₂], i.e., H is (q, q′)-safe;
if φ₀(x₀, r)∈ [symbol] _{q} for all t∈[τ₀, τ₁] and φ₀(x₀, τ₁)∈U_{q,q′} then H is not (q,q′)-safe.

The trajectory (qᵢ, φᵢ, δᵢ)_{i∈{0,1}}, represents a possible path the system can take over time, including its continuous states (qᵢ), discrete modes (φi), and mode switching times (δᵢ). The S_{q,q′} and U_{q,q′} are the safe and unsafe switching sets, respectively, as defined in Definition 8. The C_{q} and C_{q′} are the safe sets for modes q and q′, respectively, ensuring safety within those modes. The k_{q′}(φ₁(x₁, t)∈K_{q′}(φ₁(x₁, t)) ensures that the control input applied in mode q′ is always within the safe control set for that mode. The (q, q′)-safety concept, as defined in Definition 6, ensures safety during the mode transition from q to q′.

In simpler terms, Proposition 1 provides two conditions for determining whether a hybrid system will remain safe during a specific mode transition: first, if the system starts in a safe state and reaches the safe switching set before transitioning, it will remain safe in the new mode; and second if the system reaches the unsafe switching set before transitioning, it will not be safe in the new mode.

The key points of Proposition 1 is that it focuses on safety for a specific mode transition, not necessarily for all possible transitions. Further, it relies on the existence of well-defined safe and unsafe switching sets and safe sets for each mode. Finally, it assumes that the system's dynamics and control inputs are within certain bounds.

Proof of Proposition 1: First, if the switching state φ₀(x₀, δ₀)∈S_{q,q′}=Guard(q, q′)∩ [symbol] _{q}∩ [symbol] _{q′}, then φ₀(x₀, δ₀)∈ [symbol] _{q′}. Since it is known that C_{q′} is forward invariant under the safe control set K_{q′}, then φ₁(φ₀(x₀, δ₀), t)∈ [symbol] _{q′} can hold for all t∈[τ₁, τ₂]. Second, if φ₀(x₀, τ₁)∈ [symbol] _{q,q′}, state is not in the safe set C_{q′}, which directly implies that H is not (q,q′)-safe.

Proposition 1 states that the continuous state must be in the safe switching set to ensure the (q, q′)-safety. It also implies that the safety of a hybrid system can still be violated even if each mode is safe under the corresponding CBF safety filter. Next, a procedure (procedure for (q, q′)-safety synthesis) is provided to guide the system state to reach the safe switching set and avoid the unsafe switching set when the system must switch.

The procedure for (q, q′)-safety synthesis includes the following procedures: procedure 1) identifying the safe switching set S_{q,q′} and the unsafe switching set U_{q,q′} for each q→q′; procedure 2) computing the backward reachable set BackUnsafe_{q,q′} for the unsafe switching set U_{q,q′}; procedure 3) obtaining the new CBF h_{q,q′} for q→q′ by refining the initial CBF of mode q (i.e., h_{q}) via considering the backward unsafe set, wherein in an example embodiment, this is performed using dynamic programming; and procedure 4) controlling the system with h_{q,q′} when the system has mode q, and with h_{q′} when the system has mode q′.

Procedure 1 is computed based on the computational representation of the sets, i.e., safe sets and guard sets. A polyhedral set representation is closed under intersection, union and complementation and it is typically used when modeling guards in hybrid systems. However, the results on the synthesis of CBF-based controllers with polyhedral safety sets are limited. Therefore, set underapproximations using ellipsoidal sets will typically need to be computed.

Procedure 1 involves identifying the safe and unsafe switching sets for the hybrid system. The safe sets for each mode are determined. Again, these are regions in the system's state space where the system is considered safe within that particular mode. The guard conditions for each mode transition are identified. These are the conditions that trigger a switch from one mode to another. The intersection of the guard set and the safe set of the target mode are calculated. This intersection forms the safe switching set. It is the set of states where the system can safely switch to the target mode without violating safety constraints. The difference between the guard set and the safe switching set is calculated. This difference forms the unsafe switching set. It is the set of states where switching to the target mode would lead to a safety violation. Again, points to remember are that: safe switching sets are essential for ensuring safety during mode transitions; unsafe switching sets must be avoided to prevent safety violations; and the specific computational methods for identifying these sets will vary depending on the mathematical representations used for the sets.

Procedure 2 includes computation of the backward reachable sets of unsafe guard conditions, and will now be discussed.

Let C(U) be the set of all functions from positive reals to some set U, i.e., C(U)= [symbol] .

Definition 9 (Unsafe backward set): For any jump q→q′ in H_{I}, the corresponding unsafe backward set is defined by:

$${BackUnsafe}_{q , {q}^{′}} = \{ {x}_{0} ∈ {C}_{q} \vert ∀ u ∈ C ( {U}_{q} ) , ∃ T ∈ {ℝ}_{\geq 0} , s . t . {φ}_{q} ( {x}_{0} , T ) ∈ {𝒰}_{q , {q}^{′}} \} . \qquad ( 9 )$$

Again, the unsafe backward set (BackUnsafe_{q,q′}) is the set of states in mode q that, no matter what control input is applied, will inevitably lead to the unsafe switching set U_{q,q′} within a finite time. It is like the “point of no return,” where the system is doomed to enter the danger zone. In simpler terms, imagine a car driving on a slippery road with a sharp curve ahead. If the car is going too fast and is too close to the curve, there might be no way to brake in time to avoid entering the curve at a dangerous speed. The unsafe backward set would be the set of positions and speeds on the road that, even with the best braking, would still lead to the car entering the curve at an unsafe speed. It is the “zone of inevitability” where the accident becomes unavoidable.

BackUnsafe_{q,q′} contains all states that will inevitably enter the unsafe switching set U_{q,q′} in finite time no matter what control signal is applied. Therefore, the system should be controlled to avoid the unsafe backward set, otherwise it will definitely enter U_{q,q′} and invalidate safety. The backwards reachable set of the given target set may be computed. In a non-limiting example embodiment, Hamilton-Jacobi reachability is used to compute BackUnsafe_{q,q′}.

In general, the set C_{q}\BackUnsafe_{q,q′} is not a controlled invariant set. A set C is called a controlled invariant set if any trajectory starting within the set C can always be controlled to remain inside the set C. For example, the superlevel set of a CBF is a controlled invariant set. This provides motivation to find a new CBF h_{q,q′} such that for the new safe set

$${𝒞}_{q , {q}^{′}} = \{ x ∈ D ⊂ {ℝ}^{n} \vert {h}_{q , {q}^{′}} / ( x ) \geq 0 \} , \qquad ( 10 )$$

C_{q,q′}⊆C_{q}\BackUnsafe_{q,q′}. The new CBF h_{q,q′} is found by refining the initial local CBF h_{q}.

Next is procedure 3, wherein the new CBF h_{q,q′} is found, for example, by using dynamic programming. The CBF h_{q} may be updated recursively using Hamilton-Jacobi reachability. When the process terminates, a valid CBF h_{q,q′} is obtained on C_{q}\BackUnsafe_{q,q′}. The new safe set C_{q,q′} is the superlevel set of h_{q,q′}. The validity of h_{q,q′} is established in the following results.

Lemma 1: The refined CBF h_{q,q′} is valid upon convergence, i.e., there exists an extended class K function α_{q,q′}(•) such that:

$${sup}_{u ∈ {U}_{q}} \frac{\partial {h}_{q , {q}^{′}} ( x )}{\partial x} [ {f}_{q} ( x ) + {g}_{q} ( x ) u ] \geq - {α}_{q , {q}^{′}} ( {h}_{q , {q}^{′}} ( x ) ) , \qquad ( 11 )$$

for all x∈C_{q,q′}.

The refined CBF (h_{q,q′} (x)) is a CBF that has been adjusted or improved through a process, for example via dynamic programming, to better ensure safety for a specific mode transition from q to q′. The extended class K_{∞} function (α_{q,q′}(·)) is a mathematical function with specific properties that help enforce the validity of the CBF. It acts as a “safety guard” that keeps the system from violating the CBF's constraints. The gradient of the CBF (∂h_{q,q′} (x)) represents the direction of steepest ascent of the CBF, indicating where the safety boundary is most sensitive. The dynamics of the system (f_{q}(x)) captures how the system's continuous state x evolves over time within mode q. The control inputs (g_{q}(x)u) represents the influence of control actions on the system's dynamics. The inequality condition ensures that the system's evolution, even under the influence of control inputs, always stays within the safe region defined by the refined CBF.

In simpler terms: Lemma 1 provides a mathematical condition that guarantees the effectiveness of a refined CBF in ensuring safety for a specific mode transition. It is like having a safety certificate for a modified safety barrier: Lemma 1 proves that the barrier will still work as intended after the modifications. Lemma 1 focuses on the validity of a refined CBF, not necessarily the original CBF. Further, it relies on the existence of an appropriate extended class K function. Still further, it assumes that the system's dynamics and control inputs are within certain bounds.

The initial h_{q} can be considered as a good warm starting for the CBF refinement, which can accelerate the convergence of the recursive update.

Remark 2: it is known that the converged CBF recovers a valid control barrier-value function (CBVF), and that CBVF recovers the largest controlled invariant set. Hence, a refined CBF-based method in accordance with aspects of the present disclosure is not conservative under the given multiple local CBFs.

Then, the (q, q′)-safety guarantees can be obtained. K_{q,q′}(x) denotes the safe control set defined by h_{q,q′}.

Theorem 2: For any initial state x₀∈ [symbol] _{q,q′} at mode q, a hybrid system H is (q, q′)-safe under any switching feedback controller k such that k_{q}(x)∈K_{q,q′}(x) and k_{q′}(x)∈K_{q′}(x)

The initial state x₀∈C_{q,q′} means the system starts in a state that is already within the safe set Cq,q′, which is a good starting point for safety. The switching feedback controller k is a controller that can adjust the system's behavior based on its current state and mode, helping to maintain safety. The K_{q,q′}(x) and K_{q′}(x) are sets of control inputs that are guaranteed to keep the system within the safe sets for modes q and q′, respectively.

In simpler terms, Theorem 2 provides a condition for ensuring safety during a specific mode transition in a hybrid system. It says that if you start in a safe state and use a controller that only applies safe control inputs, then are guaranteed to stay safe during that transition. It is like having a safety checklist for a particular gear shift in a car: if you start in the right conditions and follow the right procedures, you will shift smoothly and safely.

For the proof of Theorem 2, consider any trajectory (qᵢ, φᵢ, δᵢ)_{i∈{0,1}} of H satisfying q₀=q and q₁=q′. For any x∈C_{q,q′}, any control input k_{q}(x)∈K_{q,q′}(x) maintains the forward invariance of the safe set C_{q,q′}. Thus, φ₀(x₀, t)∈C_{q,q′}⊆C_{q} for all t∈[0, δ₀]. Now, according to Proposition 1 discussed above, all that is needed to be proved is that the switching state is in the safe switching set, i.e., φ₀(x₀, δ₀)∈S_{q,q′}. Since φ₀(x₀, δ₀)∈C_{q,q′} [symbol] and C_{q,q′} C_{q}\BackUnsafe_{q,q′}, then φ₀(x₀, δ₀)∉BackUnsafe_{q,q′}. Also, since [symbol] U_{q,q′} BackUnsafe_{q,q′}, then φ₀(x₀, δ₀)∉U_{q,q′}. It should be noted that φ₀(x₀, δ₀)∈Guard_{q,q′}∩C_{q,q′}∩C_{q,q′}⊆Guard_{q,q′}∩C_{q}=S_{q,q′}∪U_{q,q′}. Hence, φ₀(x₀, δ₀)∈S_{q,q′} is finally obtained.

Remark 3: it should be noted that when C_{q,q′}∩S_{q,q′}=0, then there is no safe switching from mode q to mode q′. In this case, the safe control input set K_{q,q′} will prevent the continuous state from entering the guard set and switching mode. Also, when the initial state is in C_{q}\C_{q,q′}, then the system cannot be (q, q′)-safe, since the 0-superlevel set of h(q, q′) has already recovered the largest controlled invariant set.

Theorem 3: Under the assumption that: for the given set of initial conditions Q₀×X₀⊆Q×X, x₀∈ [symbol] _{q}_{₀}*≠0 for any initial state (q₀, x₀)∈Q₀×X₀; ∀(q,q′)∈ [symbol] (H): [symbol] _{q}*∩ [symbol] _{q′}*∩Guard(q, q′)≠0 or [symbol] _{q}*∩Guard(q, q′)=∅; and ∀q∈Q, ∀x∈ [symbol] _{q}*: [symbol] _{q}*(x)≠∅ if [symbol] _{q}*≠∅, then for any initial state (q₀, x₀) [symbol] ×X₀, the hybrid system H is globally safe under any switching k control which satisfies k_{q}(x(t)∈ [symbol] _{q}*(x(t)).

Theorem 3 states that if a hybrid system H meets the following conditions, it is guaranteed to be safe for all initial conditions within Q₀×X₀. The system starts in a safe state within the initial mode. For any initial state (q₀, x₀) in Q₀×X₀, the continuous state x₀ must belong to the safe set [symbol] _{q}_{₀}* for that mode. Every possible mode transition (q, q′) in the system adheres to either a safe transition or an infeasible guard. Safe transitions are the intersection of safe sets [symbol] _{q}* and [symbol] _{q′}* wherein the guard condition Guard(q, q′) is not empty, ensuring a safe transition between modes. Infeasible Guards are when the safe set [symbol] _{q}* does not intersect with the guard condition at all, preventing an unsafe transition from occurring. As for

controllability within safe sets, for any mode q and any state x within its safe set [symbol] _{q}*, there is always a safe control action to take. This means the set of safe control inputs [symbol] _{q}*(x) is not empty for any x within [symbol] _{q}* .

Theorem 3 provides a framework for verifying safety in hybrid systems by checking these conditions. It highlights the importance of designing safe sets, guard conditions, and control inputs that work together to maintain safety.

As for the proof of Theorem 3, consider any trajectory (qᵢ, φᵢ, δᵢ)_{i∈N} of H. For any i∈N\ sup N and any feedback switching control k_{q}_{ᵢ}(φᵢ(xᵢ, t))∈ [symbol] _{q}_{ᵢ}*(φᵢ(xᵢ, t)), since [symbol] _{q}_{ᵢ}*(φᵢ(xᵢ, t))⊆K_{q}_{ᵢ}_{, q}_{ᵢ₊₁}(φᵢ(xᵢ, t)), so k_{q}_{ᵢ}(φᵢ(xᵢ, t))∈K_{q}_{ᵢ}_{, q}_{ᵢ₊₁}(φᵢ(xᵢ, t)); also, k_{q}_{ᵢ₊₁}(φᵢ₊₁(xᵢ₊₁, t))∈ [symbol] _{q}_{ᵢ₊₁}(φᵢ₊₁(xᵢ₊₁, t)) ensures that φᵢ₊₁(xᵢ₊₁, t)∈ [symbol] _{q}_{ᵢ₊₁}*+ [symbol] _{q}_{ᵢ₊₁} Thus, (qᵢ, qᵢ₊₁)-safety is guaranteed according to Theorem 2 and H is globally safe.

The first assumption of Theorem 3 says the initial state should be safe. For the second assumption, it is necessary because the case [symbol] _{q}*∩ [symbol] _{q′}*∩Guard(q, q′)≠∅ means that the safe switching set as discussed above with reference to Definition 8 is not empty, which makes the safe switching feasible as discussed above with reference to Proposition 1. On the other hand, if the safe switching set is empty, safety can also be ensured as long as [symbol] _{q}*∩Guard(q, q′)=∅, i.e., the switching cannot happen, which is the latter case of the second assumption of Theorem 3.

For the third assumption of Theorem 3, it is not assumed that [symbol] _{q}*≠∅ if [symbol] _{q}*≠∅. The reason is illustrated by proving that mode q will not appear in any trajectory if [symbol] _{q}*=∅, i.e., there exists no i∈N\ sup N such that qᵢ₊₁=q. Suppose, for purposes of discussion, there exists such i∈N\ sup N with qᵢ₊₁=q, then [symbol] _{q}_{ᵢ}*∩ [symbol] _{q}_{ᵢ₊₁}∩Guard(qᵢ, qᵢ₊₁)=0 since [symbol] _{q}_{ᵢ}₊₁*≠∅.

Also, [symbol] _{q}_{ᵢ}*∩Guard(qᵢ, qᵢ₊₁)≠∅ holds, otherwise the transition from mode qᵢ to mode qᵢ₊₁ is impossible under switching control k_{q}_{ᵢ}(φᵢ(xᵢ, t))∈ [symbol] _{q}_{ᵢ}* (φᵢ(xᵢ, t)). Therefore, the second assumption cannot hold, which is a contradiction. Thus, mode q will not be in any trajectory if [symbol] _{q}*≠∅, so there is no need to pose any requirement on [symbol] _{q}*.

It should be noted that Theorem 3 provides sufficient but not necessary conditions for safe feedback switching controller design. There might exist a safe control law even if the conditions of Theorem 3 are not satisfied. There are cases where a safe switching controller exists, but Theorem 3 is not directly applicable. This will be described in greater detail with reference to FIG. 10

FIG. 10 illustrates an example hybrid automaton 1000.

As shown in the figure, hybrid automaton 1000 includes a mode q₀, a mode q₁, a mode q₂, and a mode q₃. Mode q₀ includes a modified safe set C_{q}_{₀}*, which corresponds to the set C_{q0} of safe states for mode q₀ and removes backward reachable unsafe switching sets for modes q₁-q₃ in accordance with aspects of the present disclosure. Mode q₁ includes: a safe set C_{q1,q3} corresponding the common set of safe states for mode q₁ and mode q₃; and a safe set C_{q1,q2}, which correspond to the common set of safe states for mode q₁ and mode q₂. Mode q₂ includes a safe set C_{q2}, which corresponds to the set of safe states for mode q₂. Mode q₃ includes a safe set C_{q3}, which corresponds to the set of safe states for mode q₂.

A transition from mode q₀ to mode q₁ is indicated by an arrow 1002. A transition from mode q₁ to mode q₂ is indicated by an arrow 1004. A transition from mode q₁ to mode q₃ is indicated by an arrow 1006. The Guard set for each transition is the common edge between two modes. In this case: the Guard set for the transition from mode q₀ to mode q₁ is an edge 1008; the Guard set for the transition from mode q₁ to mode q₂ is an edge 1010; and the Guard set for the transition from mode q₁ to mode q₃ is an edge 1012.

Hybrid automaton 1000 does not satisfy the second assumption of Theorem 3 since [symbol] _{q}_{₁₎}*=0 and [symbol] _{q}_{₀}*∩Guard(q₀, q₁)≠∅. However, when the trajectory starting from [symbol] _{q}_{₀}* is switching from mode q₀ to q₁, no matter whether it ends in C_{q1,q2} or C_{q1, q3}, hybrid automaton 1000 can still be safely controlled toward the next possible switch (q₁→q₂ or q₁→q₃).

Remark 4: it is possible that the above multiple CBF constraints sometimes lead to infeasibility, i.e., [symbol] _{q}*(x(t))=0. This problem can be addressed by considering a subset of feasible transitions, or even by staying in a specific mode if this mode can guarantee safety without any jumps.

In many cases, e.g., in automated driving systems, there may only be a need to consider one next dynamics mode transition, e.g., based on path planning or prediction, so one CBF constraint is sufficient to ensure safety for each mode transition (i.e., global safety reduces to sequential (q, q′)-safety). Theoretically, improving feasibility under multiple CBFs is an important problem and has been addressed using different approaches.

One may ask about the relationship between global hybrid system safety, for example as discussed above with reference to Definition 7, through multiple local CBFs and safety induced through a global CBF. In the following proposition, it is shown that the local CBFs-based method is generally less conservative than global safety guaranteed by a global CBF-based method. A global CBF for hybrid systems is first formally defined.

Definition 10: h_{g}(x) is a global CBF for the hybrid automaton H_{I} if there exists an extended class K function α(•) such that for H_{I}:

$${sup}_{u ∈ {U}_{q}} \frac{\partial {h}_{g} ( x )}{\partial x} [ {f}_{q} ( x ) + {g}_{q} ( x ) u ] \geq - α ( {h}_{g} ( x ) ) \qquad ( 12 )$$

holds for all (q, x)∈Q×X.

The global CBF (h_{g}(x)) is a function that acts as a safety constraint for a hybrid system across all of its modes. It is like a “global safety net” that ensures the system stays within safe bounds regardless of its current mode. The extended class K_{∞} function (α(•)) is a mathematical function with specific properties that help ensure the CBFs effectiveness. It is like a “safety controller” that keeps the system from straying too far from safety. The gradient of the CBF (∂h_{q}(x)) represents the direction of steepest ascent of the CBF, indicating where the safety boundary is most sensitive. The dynamics of the system (f_{q}(x)) captures how the system's continuous state x evolves over time within mode q. The control inputs (g_{q}(x)u) represents the influence of control actions on the system's dynamics. The inequality (8) condition enforces that the system's evolution always stays within the safe region defined by the CBF, even under the influence of control inputs.

In simpler terms: imagine a robot that can walk, jump, and climb, and each mode has different safety requirements to avoid collisions or falls. A global CBF would provide a unified safety constraint that ensures the robot does not collide with obstacles or fall off ledges, regardless of which mode it is currently in. It would act as a “safety supervisor” that oversees the robot's actions across all modes.

Proposition 2: If there exists a global CBF h_{g} for the hybrid automaton H_{I} for its corresponding safe set C_{g}, then there exist a local CBF h_{q} for each mode q∈Q such that the state can always stay inside C_{g}.

For the proof of Proposition 2, let h_{q}=h_{g} for each mode q∈Q. Proposition 2 establishes that a global CBF can be viewed as a special case of the local CBFs method. To further highlight the differences, several observations are made.

First, global CBF asks for the same safe state set for each flow mode, but the local CBFs-based method can support different safe sets in each mode. Therefore, control synthesis for global safety through local CBF can support a wider range of safe control applications.

Second, the single global CBF should satisfy constraints for all flow modes, but any local CBF is only responsible for its own specific mode. This implies that global CBF are harder to synthesize than local CBFs.

Third, global CBF impose more restrictive constraint conditions than local CBFs to enforce safety because of the previous observation. This means that local CBFs can lead to better system performance while ensuring safety.

### Case Studies:

As described in more detail below, two case studies are presented to illustrate the effectiveness of a multiple local CBFs-based safe control system method in accordance with aspects of the present disclosure. The approach in accordance with aspects of the present disclosure is compared with a baseline approach, wherein each initial local CBF is applied for each dynamical mode and it is unaware of the safety effects of modes switching (this approach briefly named as switch-unaware CBF). The approach in accordance with aspects of the present disclosure is compared with a global CBF method.

### A. Adaptive Cruise Control:

A simulation is first conducted on the aforementioned adaptive cruise control example. As discussed above with reference to FIG. 1, road 106 includes dry surface portion 108 and icy surface portion 110. Hence, for an autonomous system having a first dynamical mode of operation or dry surface portion 108 and a second dynamical mode of operation for icy surface portion 110, two different local CBFs are required (and assumed) to ensure safety for each mode.

The system state is x=[p υ d]^{T}, where p is the position of autonomous vehicle 104, v is the velocity of autonomous vehicle 104, and d is the distance between autonomous vehicle 104 and lead vehicle 102. The control input u is the acceleration of autonomous vehicle 104. The switching scenario is presented in FIG. 1 and hybrid system model 900 is shown in FIG. 9, where m is the mass of autonomous vehicle 104, g is the gravitational constant, v₀ is the velocity of lead vehicle 102, c_{dry} (c_{ice}) is the maximum g-force that can be applied on dry (ice) road, i.e., dry surface portion 108, and Fr_{dry}(v)=f_{0,d}v²+f_{1,d}v+f_{2,d} is the friction of dry road, i.e., dry surface portion 108. Correspondingly, Fr_{ice}(v) is the friction of ice road, i.e., icy surface portion 110, but with different respective parameters.

In a simulation, autonomous vehicle 104 is expected to drive with a desired speed v_{d} (where v_{d}>v₀), while maintaining a safe distance with lead vehicle 102. The safety specification is defined by the constraint function c(x)=d−Tₕ·v. The CBF for dry surface portion 108 is

$${h}_{dry} ( x ) = d - {T}_{h} v - \frac{{( {v}_{0} - v )}^{2}}{2 {c}_{dry} g} , \qquad ( 13 )$$

and h_{ice}(x) defined similarly by replacing c_{dry} with c_{ice} for icy surface portion 110.

An approach in accordance with aspects of the present disclosure are compared with the switch-unaware method, in which h_{dry} is applied as the safety filter while on dry surface portion 108 and h_{ice} on icy surface portion 110. An approach in accordance with aspects of the present disclosure are also compared with a global CBF method, where h_{global}=h_{ice} is applied for both modes.

For an approach in accordance with aspects of the present disclosure, h_{dry} is first refined to consider safe switching from dry surface portion 108 to icy surface portion 110, to obtain h_{dry,ice}, which is applied as the safety filter while on dry surface portion 108. The CBF is switched to h_{ice} after the dynamical mode has switched. The result is shown in FIG. 8, in which the switching state (indicated at point 804) is in the safe set of shaded area 206 of the new dynamics (c_{ice} in this example). Thus, the safety will not be violated after switching to h_{ice}.

However, as it can be observed in FIG. 6, in the switch-unaware controller, the switching point is not in the safe set of shaded area 206 (c_{ice}) and safety is violated after switching as evidenced by portion 606 of trajectory 602 within shaded area 210.

Also, in a global CBF method for example as discussed above with reference to FIG. 4, is safe but is more conservative than an approach in accordance with aspects of the present disclosure because the global CBF method decreases the velocity of autonomous vehicle 104 more and will finally reach the destination later.

### B. Dubins Car Collision Avoidance:

Consider an extended Dubins car model:

$$\dot{x} = v cos ( θ ) , \dot{y} = v sin ( θ ) , \dot{v} = a , \dot{θ} = ω , \qquad ( 14 )$$

where x, y are position of an autonomous vehicle, θ is the heading of the autonomous vehicle, and v is the speed of the autonomous vehicle.

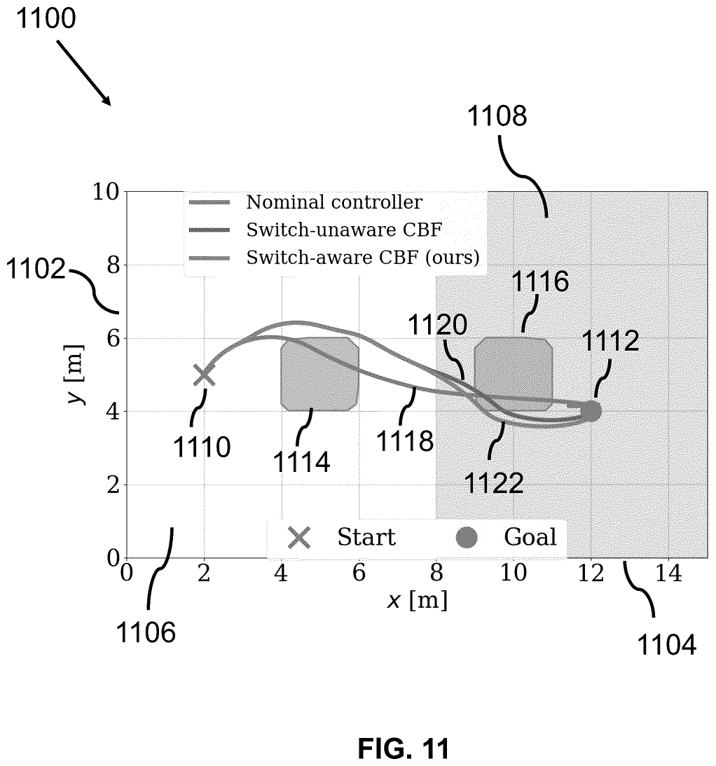

The control input includes the acceleration a and angular velocity ω. The objective of the Dubins car is to navigate to reach a goal while avoiding obstacles. This will be described in greater detail with reference to FIG. 11.

FIG. 11 illustrates a Dubins car collision avoidance example 1100. As shown in the figure, example 1100 includes a y-axis 1102, an x-axis 1104, a dry road region 1106, a wet road region 1108, a starting position 1110, a goal ending position 1112, an obstacle 1114, an obstacle 1116, a nominal trajectory 1118, a switch-unaware local CBF trajectory 1120, and a CBF trajectory 1122.

There are two local CBFs, h_{dry} for dry road region 1106 and h_{wet} for wet road region 1108. For different surfaces, the Dubins car has different control bounds.

To demonstrate the performance of the CBF-based safety filters, nominal trajectory 1118 is generated without considering obstacles 1114 and 1116. In this regard, nominal trajectory 1118 is unsafe. With the switch-unaware CBF approach, i.e., applying the original local CBFs for each mode as safety filters, switch-unaware local CBF trajectory 1120 turns to be unsafe after switching on wet road region 1108. Finally, an approach in accordance with aspects of the present disclosure refines h_{dry} and obtains h_{dry,wet} to ensure safe switching from dry road region 1106 to wet road region 1108, and h_{dry,wet} and h_{wet} are applied as safety filters before and after switching, respectively. CBF trajectory 1122, in accordance with aspects of the present disclosure, is safe. The global CBF approach is not applicable in this case study because dry road mode for dry road region 1106 and the wet road mode for wet road region 1108 have different safe regions.

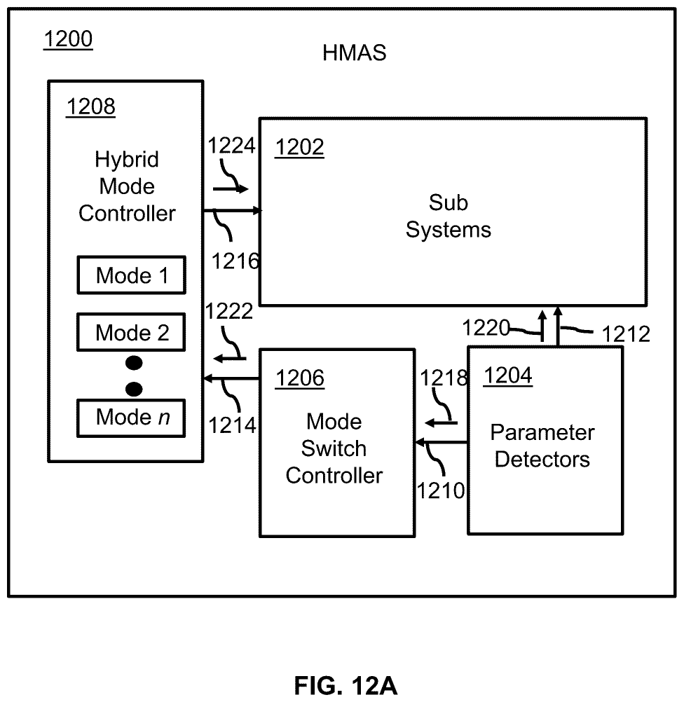

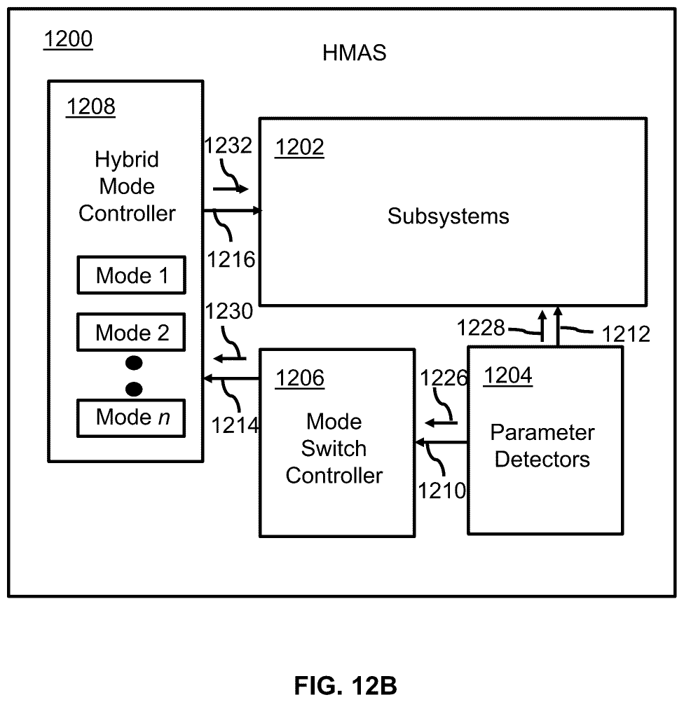

FIG. 12A illustrates an example hybrid mode autonomous system (HMAS) 1200 in accordance with aspects of the present disclosure at a time to.

As shown in the figure, HMAS 1200 includes at least one subsystem 1202, at least one parameter detector 1204, a mode switch controller (MSC) 1206, and a hybrid mode controller (HMC) 1208.

In this example, at least one subsystem 1202, at least one parameter detector 1204, MSC 1206, and HMC 1208 are illustrated as individual devices. However, in some embodiments, at least two of at least one subsystem 1202, at least one parameter detector 1204, MSC 1206, and HMC 1208 may be combined as a unitary device. Further, in some embodiments, at least one of at least one subsystem 1202, at least one parameter detector 1204, MSC 1206, and HMC 1208 may be implemented as a computer having tangible computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from and write information to the tangible computer-readable media. In the alternative, the tangible computer-readable media may be integral to the processor. The processor and the tangible computer-readable media may reside in an integrated circuit (IC), an application specific integrated circuit (ASIC), or large-scale integrated circuit (LSI), system LSI, super LSI, or ultra LSI components that perform a part or all of the functions described herein. In the alternative, the processor and the tangible computer-readable media may reside as discrete components.

Example tangible computer-readable media may also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

In this example, at least one parameter detectors 1204 are configured to communicate with MSC 1206 via a communication channel 1210 and to communicate with at least one subsystem 1202 via a communication channel 1212.

MSC 1206 is additionally configured to communicate with HMC 1208 via a communication channel 1214.

HMC 1208 is additionally configured to communicate with at least one subsystem 1202 via a communication channel 1216.

HMAS 1200 may be any machine or system capable of operating independently and making decisions without direct human input. In some embodiments, HMAS 1200 may be an independent system, e.g., an autonomous robot used in a manufacturing line. In some embodiments, HMAS 1200 may be part of a larger system that is not itself autonomous, e.g., an autonomous automatic parking system for a vehicle.

The at least one subsystem 1202 includes at least one subsystem that is hybrid autonomous, i.e., autonomously operates in at least two different modes. For example, an autonomous vehicle may include: an autonomous hybrid mode acceleration system; an autonomous hybrid mode braking system; an autonomous hybrid mode detection system; etc. At least one of the subsystems of at least one subsystem 1202 will be configured to operate in a first manner in one mode and to operate in another manner in another mode.

Consider autonomous vehicle 104 discussed above with reference to FIG. 1. In a non-limiting example where autonomous vehicle 104 is controlled in accordance with aspects of the present disclosure, the subsystems of autonomous vehicle 104 will operate differently when operating under the dry surface mode as compared to the icy surface mode. For example, under the dry surface mode, the acceleration subsystem may be configured to enable a predetermined maximum acceleration a_{md}, whereas under the icy surface mode, the acceleration subsystem may be configured to enable a predetermined maximum acceleration aₘᵢ, wherein a_{md}>aₘᵢ (it is prevented from accelerating as much on ice).

The at least one parameter detector 1204 includes at least one device or system that may be configured to detect a parameter and output a detected parameter signal based on the detected parameter, non-limiting examples of which include: temperature detectors; cameras; photodetectors; microphones; Radars; Lidars; pressure sensors; vibration sensors; accelerometers; global positioning system (GPS) receivers; radio receivers; thermal sensors.

MSC 1206 may be any device or system that may be configured to output a mode control signal based on the detected parameter signal.

HMC 1208 may be any device or system that may be configured to output a subsystem control signal based on the mode control signal. In some embodiments, HMC 1208 includes a processor and a memory that includes instructions and a data structure stored therein. The data structure may be any known type of data structure, a non-limiting example of which includes a look-up table, that associates each one of at least two modes of operation of the subsystems of at least one subsystem 1202 with respective operating parameters.

In a non-limiting example where autonomous vehicle 104 is controlled in accordance with aspects of the present disclosure, the look-up table may associate the dry surface mode with a predetermined maximum acceleration a_{md} of the acceleration system, and may associate the icy surface mode a predetermined maximum acceleration aₘᵢ, wherein a_{md}>aₘᵢ.

The processor in HMC may execute the instructions in the memory to cause the HMC to output the subsystem control signal so as to cause the subsystems of at least one subsystem 1202 to operate in accordance with the parameters associated with the mode for which HMAS 1200 is to operate.

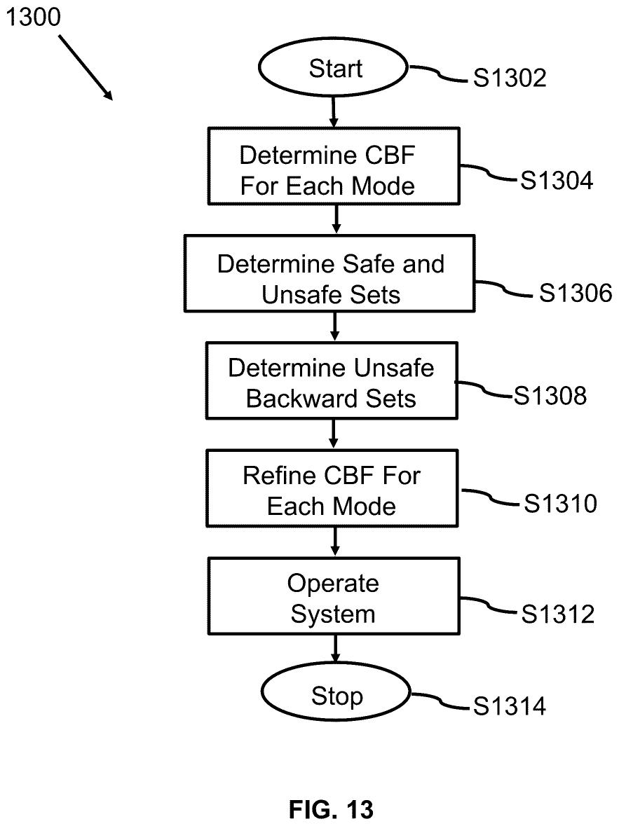

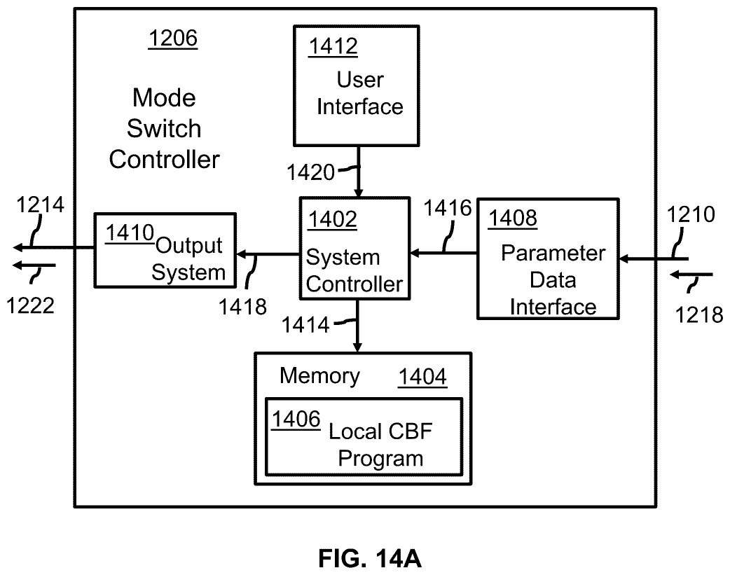

FIG. 13 illustrates an example method 1300 of operating MSC 1206 in accordance with aspects of the present disclosure.

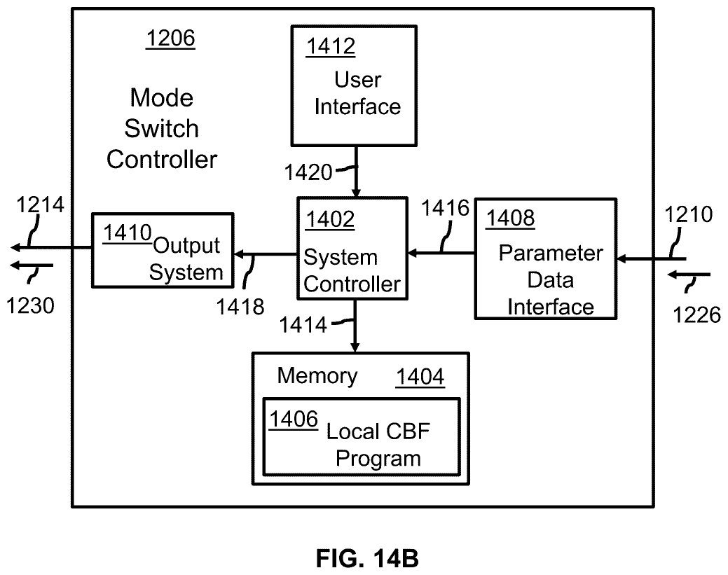

As shown in the figure, method 1300 starts (S1302) and the CBF for each mode is determined (S1304). For example, as shown in FIG. 12A, MSC 1206 determines the CBF for each mode. This will be described in greater detail with reference to FIG. 14A.

FIG. 14A illustrates a more detailed view of MSC 1206 of FIG. 12A.

As shown in FIG. 14A, MSC 1206 includes a system controller 1402, a memory 1404 having data and a local CBF program 1406 stored therein, a parameter data interface 1408, an output system 1410, and a user interface (UI) 1412.

In this example, system controller 1402, memory 1404, parameter data interface 1408, output system 1410, and UI 1412 are illustrated as individual devices. However, in some embodiments, at least two of system controller 1402, memory 1404, parameter data interface 1408, output system 1410, and UI 1412 may be combined as a unitary device. Further, in some embodiments, at least one of system controller 1402, memory 1404, parameter data interface 1408, output system 1410, and UI 1412 may be implemented as a computer having tangible computer-readable media for carrying or having computer-executable instructions or data structures stored thereon.

In this example, system controller 1402 may be configured to communicate with memory 1404 via a communication channel 1414, to communicate with parameter data interface 1408 via a communication channel 1416, to communicate with output system 1410 via a communication channel 1418, and to communicate with UI 1412 via a communication channel 1420.

Parameter data interface 1408 is additionally configured to communicate with at least one parameter detector 1204 via communication channel 1210.

Output system 1410 is additionally configured to communicate with HMC 1208 via communication channel 1214.

System controller 1402 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of MSC 1206 in accordance with the embodiments described in the present disclosure.

Memory 1404 may be any known type of non-volatile memory.

In some embodiments, as will be described in greater detail below, local CBF program 1406 includes instructions, that when executed by system controller 1402 cause MSC 1206 to instruct HMC 1208 to output a first mode control signal; determine, based on a detected parameter signal, a first CBF, and a second CBF, whether a subsystem of at least one subsystem 1202 should operate in the second mode to cause the subsystem to, one of: maximize a first predetermined operational parameter; minimize a second predetermined operational parameter; and guarantee a third operational parameter; and instruct HMC 1208, based on the detected parameter signal, the first CBF, and the second CBF, to output a second mode control signal so as to cause the subsystem to operate in the second mode to, perform the one of: maximize the first predetermined operational parameter; minimize the second predetermined operational parameter; and guarantee the third operational parameter, wherein the first CBF is based on the subsystem operating in the first mode and the subsystem switching from operating in the first mode to operating in the second mode, and wherein the second CBF is based on the subsystem operating in the second mode.

In some embodiments, as will be described in greater detail below, local CBF program 1406 includes instructions, that when executed by system controller 1402 cause MSC 1206 to determine, based on the detected parameter signal, the first CBF, and the second CBF, whether a subsystem of at least one subsystem 1202 should operate in the second mode to cause the subsystem to guarantee safety to HMAS 1200 as the third operational parameter.

In some embodiments, as will be described in greater detail below, when a parameter detector of at least one parameter detector 1204 may be configured to detect a parameter as at least one of the group of parameters comprising velocity of HMAS 1200, acceleration of HMAS 1200, distance of HMAS 1200 to a location, distance of HMAS 1200 to an object, a condition of an environment for which HMAS 1200 is disposed, and a parameter of a subsystem of at least one subsystem 1202, local CBF program 1406 includes instructions, that when executed by system controller 1402 cause MSC 1206 to determine, based on the detected parameter signal, whether the subsystem should operate in the second mode, wherein the detected parameter signal is based on the at least one of the group of parameters comprising the velocity of HMAS 1200, the acceleration of HMAS 1200, the distance of HMAS 1200 to a location, the distance of HMAS 1200 to an object, the condition of the environment for which HMAS 1200 is disposed, and the parameter of the subsystem.

In some embodiments, as will be described in greater detail below, when HMAS 1200 is an autonomous vehicle and a parameter detector of at least one parameter detector 1204 may be configured to detect the parameter as a velocity of the autonomous vehicle, local CBF program 1406 includes instructions, that when executed by system controller 1402 cause MSC 1206 to determine, based on the detected parameter signal, whether a subsystem of at least one subsystem 1202 should operate in the second mode, wherein the detected parameter signal is based on the velocity of the autonomous vehicle. In some of these embodiments, a will be described in greater detail below, local CBF program 1406 includes instructions, that when executed by system controller 1402 cause MSC 1206 to determine, based on the detected parameter signal, the first CBF, and the second CBF, whether the subsystem should operate in the second mode to cause the subsystem to guarantee safety to the autonomous vehicle as the third operational parameter.

In some embodiments, as will be described in greater detail below, when HMAS 1200 is an autonomous vehicle and a parameter detector of at least one parameter detector 1204 may be configured to detect the parameter as a condition of a road upon which the autonomous vehicle travels as an environment for which the autonomous vehicle is disposed, local CBF program 1406 includes instructions, that when executed by system controller 1402 cause MSC 1206 to determine, based on the detected parameter signal, whether a subsystem of at least one subsystem 1202 should operate in the second mode, wherein the detected parameter signal is based on the condition of the environment for which the autonomous vehicle is disposed.

Parameter data interface 1408 may be any device or system that may be configured to receive detected parameter signals from at least one parameter detector 1204.

Output system 1410 may be any device or system that may be configured to output a mode control signal.

UI 1412 may be any device or system that may be configured to enable a user to access and control system controller 1402. UI 1412 may include one or more layers including a human-machine interface (HMI) machines with physical input hardware such a keyboards, mice, game pads and output hardware such as computer monitors, speakers, and printers. Additional UI layers in UI component xxx may interact with one or more human senses, including: tactile UI (touch), visual UI (sight), and auditory UI (sound).

In operation, in some embodiments, system controller 1402 may execute instructions in local CBF program to establish a local CBF for each mode for HMAS 1200. This may be performed by any known method. System controller 1402 may then execute instructions in local CBF grogram to store the local CBFs for each mode for HMAS 1200 into memory 1404.

In some embodiments, a local CBF for each mode for HMAS 1200 may be provided from an external source (not shown). In some of these embodiments, a user may instruct system controller 1402, via UI 1412, to store the provided local CBFs in memory 1404.

The above-discussion describes the use of CBFs for safety of an autonomous system. In the non-limiting examples discussed above with reference to FIG. 1, HMAS 1200 is autonomous vehicle 104. It should be noted that in accordance with aspects of the present disclosure, the “safe sets” more generally describes state sets wherein the CBF causes at least one subsystem of an autonomous system to, one of: maximize a first predetermined parameter; minimize a second predetermined operational parameter; and guarantee a third operational parameter.

As for maximizing a first predetermined parameter, for example, “safe sets” in accordance with aspects of the present disclosure may describe state sets wherein the CBF causes at least one subsystem of an autonomous hybrid system to maximize some parameter. For example, consider the case of an autonomous anesthesia providing hybrid system, a parameter to be maximized may be safety of the patient under anesthesia, wherein a first induction anesthesia mode (q₀) has an induction CBF, a second maintenance anesthesia mode (q₁) has a maintenance CBF, and a third recovery anesthesia mode (q₂) has a recovery CBF. Each one of the induction CBF, the maintenance CBF, and the recovery CBF may correspond to different respective permitted parameters of the autonomous anesthesia providing hybrid system, e.g., vital sign detection rates, fluid flow rates, etc., that are chosen to maximize safety to the patient.

As for minimizing a second predetermined parameter, for example, “safe sets” in accordance with aspects of the present disclosure may describe state sets wherein the CBF causes at least one subsystem of an autonomous hybrid system to minimize some parameter. For example, in the case of an autonomous fast-food preparation hybrid system, a parameter to be minimized may be time in food preparation, wherein a first ingredient gathering mode (q₀) has a gathering CBF, a second ingredient combining mode (q₁) has a combining CBF, and a third product wrapping mode (q₂) has a wrapping CBF. Each one of the gathering CBF, the combining CBF, and the wrapping CBF may correspond to different respective permitted parameters of the autonomous fast-food preparation hybrid system, e.g., types of movement, number of moves, etc., that are chosen to minimizing time spent in preparing the food.

As for guaranteeing a third predetermined parameter, for example, “safe sets” in accordance with aspects of the present disclosure may describe state sets wherein the CBF causes at least one subsystem of an autonomous hybrid system to guarantee some parameter. For example, in the case of an autonomous drone hybrid system, a parameter to be guaranteed may be angle of roll in a roll, pitch, yaw coordinate system, wherein a first air traversing mode (q₀) has an air CBF, a second water traversing mode (q₁) has a water CBF, and a third land traversing mode (q₂) has a land CBF. Each one of the air CBF, the water CBF, and the land CBF may correspond to different respective permitted parameters of the autonomous drone hybrid system, e.g., wing position, internal payload position, etc., that are chosen to guarantee that the roll of the autonomous drone hybrid system is maintained within a predetermined range.

Returning to FIG. 13, after the CBF for each mode is determined (S1304), safe and unsafe sets are determined (S1306). For example, as shown in FIG. 12A, MSC 1206 determines safe and unsafe sets.

In an example embodiment, as shown in FIG. 14A, system controller 1402 may be configured to execute instructions in local CBF program 1406 to determine safe and unsafe sets. This may be performed as discussed above with reference to procedure 1 of the procedure for (q, q′)-safety synthesis.

For example, as discussed above with reference to the related art local CBF method of FIGS. 5A-B, the safe and unsafe sets for each mode are determined.

In operation, in some embodiments, system controller 1402 may execute instructions in local CBF program to determine safe and unsafe sets for controlling HMAS 1200 with local CBFs. This may be performed by any known method. System controller 1402 may then execute instructions in local CBF program to store the safe and unsafe sets for HMAS 1200 into memory 1404.

In some embodiments, the safe and unsafe sets for HMAS 1200 being controlled with local CBFs may be provided from an external source (not shown). In some of these embodiments, a user may instruct system controller 1402, via UI 1412, to store the safe and unsafe sets for HMAS 1200 in memory 1404.

The above-discussion describes the safe and unsafe sets for an autonomous system that is controlled with local CBFs.

For example, consider the case of the autonomous anesthesia providing hybrid system, wherein the parameter to be maximized is safety of the patient under anesthesia. The first induction anesthesia mode (q₀) has an induction CBF that might be envisioned as an array similar to array 502 discussed above with reference to FIG. 5A, wherein the induction CBF will include a plurality of safe and unsafe states, i.e., safe states in this case that maximize safety of the patient under anesthesia and unsafe states in this case that do not maximize safety of the patient under anesthesia. Similarly, the second maintenance anesthesia mode (q₁) has a maintenance CBF that might be envisioned as an array similar to array 508 discussed above with reference to FIG. 5B, wherein the maintenance CBF will include a plurality of safe and unsafe states. Although arrays 502 and 508 are provided merely for purposes of discussion, what is intended to be illustrated is that for any particular mode, it may have its own respective safe and unsafe states. With this in mind, the third recovery anesthesia mode (q₂) has a recovery CBF that might be envisioned as a similar array, wherein the recovery CBF will include a plurality of safe and unsafe states.

For another non-limiting example, in the case of the autonomous fast-food preparation hybrid system, a parameter to be minimized may be time in food preparation. The first ingredient gathering mode (q₀) has a gathering CBF that might be envisioned as an array, wherein the gathering CBF will include a plurality of safe and unsafe states, i.e., safe states in this case that minimize time in food preparation and unsafe states in this case that do not minimize time in food preparation. Similarly, the second ingredient combining mode (q₁) has a combining CBF that might be envisioned as an array, wherein the combining CBF will include a plurality of safe and unsafe states. Finally, the third product wrapping mode (q₂) has a wrapping CBF that might be envisioned as a similar array, wherein the wrapping CBF will include a plurality of safe and unsafe states.

For another non-limiting example, in the case of the autonomous drone hybrid system, the parameter to be guaranteed may be angle of roll in a roll, pitch, yaw coordinate system. The first air traversing mode (q₀) has an air CBF that might be envisioned as an array, wherein the air CBF will include a plurality of safe and unsafe states, i.e., safe states in this case that guarantee a predetermined angle of roll and unsafe states in this case that do not guarantee a predetermined angle of roll. Similarly, the second water traversing mode (q₁) has a water CBF that might be envisioned as an array, wherein the water CBF will include a plurality of safe and unsafe states. Finally, the third land traversing mode (q₂) has a land CBF that might be envisioned as a similar array, wherein the wrapping CBF will include a plurality of safe and unsafe states.

Returning to FIG. 14A, after the safe/unsafe states are determined for each mode, system controller 1402 may be configured to execute instructions in local CBF program 1406 to determine the safe switching set S_{q,q′} and the unsafe switching set U_{q,q′} for each q→q′. This may be performed as discussed above with reference to procedure 1 of the procedure for (q, q′)-safety synthesis.

Returning to FIG. 13, after safe and unsafe switching sets are determined (S1306), unsafe backward sets are determined (S1308). For example, returning to FIG. 14A, system controller 1402 may be configured to execute instructions in local CBF program 1406 to determine the reachable set BackUnsafe_{q,q′} for the unsafe switching set U_{q,q′} for each q→q′. This may be performed as discussed above with reference to procedure 2 of the procedure for (q, q′)-safety synthesis.

For example, in the non-limiting examples discussed above with reference to FIG. 1, HMAS 1200 is autonomous vehicle 104, which includes the dry surface mode (in this example q₀) for operating while driving on dry surface portion 108 and the icy surface mode (in this example q₁) for operating while driving on icy surface portion 110.

As mentioned above, system controller 1402 may be configured to execute instructions in local CBF program 1406 to determine the respective safe and unsafe switching set S_{q0,q1} and the unsafe switching set U_{q0,q1} for switching from q₀→q₁, i.e., in this case for switching from the dry surface mode (q₀) to the icy surface mode (q₁).

However, there may be some states in dry surface mode (q₀) that system controller 1402 determines are safe states, but the act of switching from one mode to another mode, i.e., in this case switching from the dry surface mode (q₀) to the icy surface mode (q₁), changes a previously determined safe state in the icy surface mode (q₁) to an unsafe state in the icy surface mode (q₁). These problematic unsafe states are discussed above with reference to the plurality of striped unsafe states, a sample of which is indicated as unsafe state 518, of FIG. 5C of the related art local CBF control systems. In accordance with aspects of the present disclosure, system controller 1402 may be configured to execute instructions in local CBF program 1406 to determine these unsafe states as the reachable set BackUnsafe_{q,q′} for the unsafe switching set U_{q,q′} for each q→q′. As discussed above with reference to FIG. 7A, in accordance with aspects of the present disclosure, these states that are ultimately identified as additional unsafe states are the plurality of striped unsafe states, a sample of which is indicated as unsafe state 704.

Returning to FIG. 13, after unsafe backward sets are determined (S1308), the CBF for each mode is refined (S1310). For example, returning to FIG. 14A, system controller 1402 may be configured to execute instructions in local CBF program 1406 to refine the CBF for each mode in a manner as discussed above with reference to procedure 3 of the procedure for (q, q′)-safety synthesis.

For example, in the non-limiting examples discussed above with reference to FIG. 1, HMAS 1200 is autonomous vehicle 104, which includes the dry surface mode (in this example q₀) for operating while driving on dry surface portion 108 and the icy surface mode (in this example q₁) for operating while driving on icy surface portion 110.

As mentioned above, system controller 1402 may be configured to execute instructions in local CBF program 1406 to modify the safe set for the dry surface mode (q₀), such that when autonomous vehicle 104 switches from dry surface portion 108 to icy surface portion, and therefore switches from the dry surface mode (q₀) to the icy surface mode (q₁), the safe set for the icy surface mode (q₁) maintains safety. For example, by comparing array 502 as shown in FIG. 5A with array 702 as shown in FIG. 7A, array 702 includes additional unsafe states, a sample of which is indicated as unsafe state 704. These additional unsafe states in array 702 are states that, would have been identified as a safe state for autonomous vehicle 104 to operate when operating in the dry surface mode (q₀), but in accordance with aspects of the present disclosure: are identified as causing unsafe states in the icy surface mode (q₁), when autonomous vehicle 104 operates in the dry surface mode (q₀) and switches to the icy surface mode (q₁); and are then identified as an unsafe state for autonomous vehicle 104 to operate when operating in the dry surface mode (q₀). In this manner, the dry surface mode (q₀) is refined in accordance with aspects of the present disclosure.

Returning to FIG. 13, after the CBF for each mode is refined (S1310), the system is operated (S1312). For example, consider the non-limiting examples discussed above with reference to FIG. 1, wherein HMAS 1200 is autonomous vehicle 104. Let autonomous vehicle 104 be driving on dry surface portion 108. This will be described in greater detail with reference to FIG. 12A.

As shown in the figure, at least one parameter detector 1204 is going to be detecting at least one parameter for autonomous vehicle 104. For example: a radar may be detecting surrounding objects; a thermometer may detect the outside temperature; a video camera may be imaging the road; a radio receiver may be receiving weather updates for the area; etc. For purposes of discussion only, let at least one parameter detector 1204 detect parameters associated with dry surface portion 108. At least one parameter detector 1204 output a detected parameter signal 1218 to MSC 1206.

In some embodiments, at least one parameter detector 1204 includes a plurality of detectors, wherein each of the plurality of detectors generates a distinct respective detected parameter output based on a distinctly detected respective parameter. For example, a thermometer may output a temperature signal based on a detected temperature, whereas an icy surface detector may output a binary output representing whether an icy surface exists or not. In some of these embodiments, detected parameter signal 1218 may be composed of some combination of the plurality of distinct respective detected parameter outputs. In other of these embodiments, detected parameter signal 1218 may be composed of a sequence of a plurality of independent detected parameter signals corresponding to the plurality of distinct respective detected parameter outputs.

In some embodiments, at least one parameter detector 1204 may continuously output detected parameter signals. In some embodiments, at least one parameter detector 1204 may output detected parameter signals at predetermined periods. In some embodiments, at least one parameter detector 1204 may output parameter signals based on whether there has been a change in a detected parameter.

Returning to FIG. 14A, parameter data interface 1408 receives detected parameter signal 1218 and provides detected parameter signal 1218 to system controller 1402.

Local CBF program 1406 may have a data structure stored therein. The data structure may be any known type of data structure, a non-limiting example of which includes a look-up table, that associates different detected parameter signals with different respective modes for which HMAS 1200 may operate. Further, the data structure additionally associates safe and unsafe states for each respective mode of operation in a manner as discussed above with reference to the procedure for (q, q′)-safety synthesis.

In some embodiments, local CBF program 1406 may have the data structure stored therein a priori. In some embodiments, UI 1412 may enable a user to store the data structure into local CBF program 1406. In some embodiments, UI 1412 may enable a user to modify a data structure that is stored within local CBF program 1406. In some embodiments, UI 1412 may enable a user to replace a data structure that is stored within local CBF program 1406 with a new data structure. In some embodiments, UI 1412 may enable a user to overwrite a data structure that is stored within local CBF program 1406 with a new data structure.

In a non-limiting example where autonomous vehicle 104 is controlled in accordance with aspects of the present disclosure, the look-up table may associate a detected parameter signal corresponding to dry surface portion 108 with a predetermined dry surface mode and may associate a detected parameter signal corresponding to icy surface portion 110 with a predetermined icy surface mode. In this example, at time to corresponding to FIG. 14A, detected parameter signal 1218 corresponds to dry surface portion 108.

System controller 1402 may be configured to execute instructions in local CBF program 1406 to cause system controller 1402 to determine which mode HMAS 1200 should operate and output a mode control signal 1222 to HMC 1208, based on the determination.

In a non-limiting example where autonomous vehicle 104 is controlled in accordance with aspects of the present disclosure, system controller 1402 may be configured to execute instructions in local CBF program 1406 to cause system controller 1402 to determine that autonomous vehicle 104 should operate in a safe state of the dry surface mode and cause output system 1410 to output mode control signal 1222 to HMC 1208, based on the determination. In this example, at time to corresponding to FIG. 14A, mode control signal 1222 corresponds to dry surface portion 108.

Returning to FIG. 12A, HMC 1208 receives mode control signal 1222. In a non-limiting example where autonomous vehicle 104 is controlled in accordance with aspects of the present disclosure, the look-up table of HMC 1208 may associate a safe state of the dry surface mode as indicated by mode control signal 1222 with a predetermined maximum acceleration a_{md} of the acceleration system.

The processor in HMC may execute the instructions in the memory to cause the HMC to output a subsystem control signal 1224 so as to cause the subsystems of at least one subsystem 1202 to operate in accordance with the parameters associated with the mode for which HMAS 1200 is to operate.

In a non-limiting example where autonomous vehicle 104 is controlled in accordance with aspects of the present disclosure, subsystem control signal 1224 may cause the acceleration subsystem of autonomous vehicle 104 to operate with the predetermined maximum acceleration a_{md}.

Eventually, at least one parameter detector 1204 may detect parameters that will ultimately cause HMAS 1200 to switch to a new mode of operation. For example, consider the non-limiting examples discussed above with reference to FIG. 1, wherein HMAS 1200 is autonomous vehicle 104. Let autonomous vehicle 104 be driving on icy surface portion 110. This will be described in greater detail with reference to FIG. 12B.

FIG. 12B illustrates the hybrid mode autonomous system of FIG. 12A at a time ti.

As shown in the figure, at least one parameter detector 1204 is going to be detecting at least one parameters for autonomous vehicle 104. For purposes of discussion only, let at least one parameter detector 1204 detect parameters associated with icy surface portion 110. At least one parameter detector 1204 output a detected parameter signal 1226 to MSC 1206. This will be described in greater detail with reference to FIG. 14B.

FIG. 14B illustrates MSC 1206 of HMAS 1200 as shown in FIG. 12B.

As shown in FIG. 14B, parameter data interface 1408 receives detected parameter signal 1226 and provides detected parameter signal 1226 to system controller 1402.

In this example, at time ti corresponding to FIG. 14B, detected parameter signal 1226 corresponds to icy surface portion 110.

System controller 1402 may be configured to execute instructions in local CBF program 1406 to cause system controller 1402 to determine which mode HMAS 1200 should operate and output a mode control signal 1230 to HMC 1208, based on the determination.

In a non-limiting example where autonomous vehicle 104 is controlled in accordance with aspects of the present disclosure, system controller 1402 may be configured to execute instructions in local CBF program 1406 to cause system controller 1402 to determine that autonomous vehicle 104 should operate in a safe state of the icy surface mode and cause output system 1410 to output mode control signal 1230 to HMC 1208, based on the determination. In this example, at time ti corresponding to FIG. 14B, mode control signal 1230 corresponds to icy surface portion 110, after autonomous vehicle 104 had just been operating in a dry surface mode and is now switching to icy surface mode.

Returning to FIG. 12B, HMC 1208 receives mode control signal 1230. In a non-limiting example where autonomous vehicle 104 is controlled in accordance with aspects of the present disclosure, the look-up table of HMC 1208 may associate a safe state of the icy surface mode as indicated by mode control signal 1230 with a predetermined maximum acceleration aₘᵢ of the acceleration system.

The processor in HMC may execute the instructions in the memory to cause HMC 1208 to output a subsystem control signal 1232 so as to cause the subsystems of at least one subsystem 1202 to operate in accordance with the parameters associated with the mode for which HMAS 1200 is to operate.

In a non-limiting example where autonomous vehicle 104 is controlled in accordance with aspects of the present disclosure, subsystem control signal 1232 may cause the acceleration subsystem of autonomous vehicle 104 to operate with the predetermined maximum acceleration aₘᵢ.

Returning to FIG. 13, after the system is operated (S1312), method 1300 stops (S1314).

The present disclosure provides a class of safe controllers for safety-critical systems that have hybrid dynamics. For example, autonomous vehicles driving on different road conditions (e.g., dry vs ice road, gravel, etc.) have different dynamics over the different parts of the road. Another example is a bipedal robot switching left foot and right foot to move forward. Each such distinct mode of operation/behavior requires a different mathematical model of the system and, typically, a different controller design. These different qualitative system behaviors are referred to as “modes of operation” or simply “modes.”

Existing technology can only guarantee that the vehicle/robot behavior is safe for each operating mode without consideration of the switching dynamics between different modes during runtime. This provides motivation to design a new class of safe controllers that can ensure safety for the whole system after considering the switching dynamics of autonomous systems. Using hybrid control barrier functions (CBFs) in accordance with aspects of the present disclosure, the proposed quadratic program based control method optimizes a user-specified objective function (e.g., less fuel usage, less traveled distance, etc.). A framework in accordance with aspects of the present disclosure can be applied to any autonomous system with hybrid dynamics, e.g., with switching modes of operation.

The problem to be addressed for the present disclosure is the following: given a general class of control-affine hybrid dynamical systems and a set of safe system states, design a control law such that the hybrid systems will never leave the safe set.

To ensure safety for dynamical systems, CBF is usually used as an inequality constraint in the quadratic program (QP) optimization problem to modify the original unsafe control input and finally output safe control input, and this process is referred to as CBF-QP. Some related art systems attempt address the safety control problem for hybrid dynamical systems via CBF based controllers. For example, a global CBF solves this problem by assuming all subsystems share the common CBF and thus safety can be preserved even after considering switching. However, a global CBF is not necessary and too conservative to ensure the safety for hybrid systems. In accordance with the present disclosure, the global CBF condition is relaxed to multiple local CBFs to ensure safety and local CBFs are shown to be more necessary than the global CBF. Another similar direction is studying the stability for hybrid systems, which is a dual notion of safety. Many technologies have been proposed to try to verify/ensure the stability using multiple local Lyapunov functions (which are similar to CBFs). However, there is no technology for ensuring safety using multiple CBFs and aspects of the present disclosure are the first one to do so.

A local CBF-based control framework in accordance with aspects of the present disclosure is an improvement over current technology like the global CBF based framework in since global CBF is provably a special case of local CBFs in accordance with aspects of the present disclosure and it is much easier to find such local CBFs than the global CBF. Compared with global CBF method, benefits of a system and method in accordance with aspects of the present disclosure are: 1) finding/constructing a valid global CBF is more difficult since it has more restrictive requirements and stronger assumptions than local CBFs; and 2) after applying CBF framework, a local-CBFs-based control framework in accordance with aspects of the present disclosure is less conservative regarding system performance, since it poses less restriction on system's behavior.

For the given hybrid dynamical system, a control input is provided that maximizes the system's objective function (e.g., less fuel consumption, less travelled distance or time for automated cars). However, this control input is potentially unsafe since safety is not considered while computing this control input, so it might cause unsafe behavior of hybrid systems. To ensure safety, proposed local CBFs-based safety layer (i.e., CBF-QP) in accordance with aspects of the present disclosure are used to modify unsafe control inputs and finally all control inputs implemented on hybrid systems are safe. Thus, the safety is preserved.

The main feature of a system and method in accordance with aspects of the present disclosure is four-fold: 1) safety can be jeopardized under some switching signal even if all subsystems can be safe through control is revealed; 2) the unsafe switching state set (for example, find those unsafe switching states from dry road to ice road) is identified; 3) the backward reachable set of this unsafe switching state, i.e., those state who will inevitably reach the unsafe switching states, are computed; and 4) the initial local CBF (e.g., CBF of the dry road) are updated to avoid the unsafe backward set; thus, as system in accordance with aspects of the present disclosure can ensure that the unsafe switching will not happen.

The foregoing description of various examples have been presented for purposes of illustration and description. It is not intended to be exhaustive or to limit the systems and methods in accordance with the present disclosure to the precise forms disclosed, and obviously many modifications and variations are possible in light of the above teaching. The examples, as described above, were chosen and described in order to enable others skilled in the art to best utilize the systems and methods in accordance with the present disclosure in various examples and with various modifications as are suited to the particular use contemplated. It is intended that the scope of the systems and methods in accordance with the present disclosure be defined by the claims appended hereto.

What is claimed is:

1. A mode switch controller comprising:
a memory having instructions stored therein; and
a processor configured to execute the instructions stored in said memory to cause said mode switch controller to:
instruct a hybrid mode controller to output a first mode control signal to cause a system to operate in a first mode; and
instruct the hybrid mode controller, based on a detected parameter signal, a first control barrier function, and a second control barrier function, to output a second mode control signal to cause a system to operate in a second mode,
wherein the first control barrier function is based on the system operating in the first mode and the system switching from operating in the first mode to operating in the second mode, and
wherein the second control barrier function is based on the system operating in the second mode.

2. The mode switch controller of claim 1, wherein the second control barrier function is based on the system operating in the second mode and the system switching from operating in the first mode to operating in the second mode.

3. The mode switch controller of claim 1, wherein said processor is configured to execute the instructions stored in said memory to additionally cause said mode switch controller to determine, based on the detected parameter signal, the first control barrier function, and the second control barrier function, whether the system is to operate in the second mode to cause the system to guarantee safety to the system.

4. The mode switch controller of claim 1, wherein said processor is configured to execute the instructions stored in said memory to additionally cause said mode switch controller to:
determine, based on the detected parameter signal, whether the system is to operate in the second mode,
wherein the detected parameter signal is based on the at least one of a group of parameters comprising velocity of the system, acceleration of the system, distance of the system to a location, distance of the system to an object, a condition of the environment for which the system is disposed, and a parameter of the system.

5. The mode switch controller of claim 1, wherein said processor is configured to execute the instructions stored in said memory to additionally cause said mode switch controller to:
determine, based on the detected parameter signal, whether the system is to operate in the second mode,
wherein the detected parameter signal is based on a velocity of an autonomous vehicle.

6. The mode switch controller of claim 5, wherein said processor is configured to execute the instructions stored in said memory to additionally cause said mode switch controller to determine, based on the detected parameter signal, the first control barrier function, and the second control barrier function, whether the system is to operate in the second mode to cause the system to guarantee safety to the autonomous vehicle.

7. The mode switch controller of claim 1, wherein said processor is configured to execute the instructions stored in said memory to additionally cause said mode switch controller to:
determine, based on the detected parameter signal, whether the system is to operate in the second mode,
wherein the detected parameter signal is based on a condition of an environment for which an autonomous vehicle is disposed.

8. A method comprising:
instructing, via a processor configured to execute the instructions stored in a memory, a hybrid mode controller to output the first mode control signal to cause a system to operate in a first mode;
instructing, via the processor and based on a detected parameter signal, a first control barrier function, and a second control barrier function, the hybrid mode controller to output a second mode control signal to cause the system to operate in a second mode,
wherein the first control barrier function is based on the system operating in the first mode and the system switching from operating in the first mode to operating in the second mode, and
wherein the second control barrier function is based on the system operating in the second mode.

9. The method of claim 8, wherein the second control barrier function is based on the system operating in the second mode and the system switching from operating in the first mode to operating in the second mode.

10. The method of claim 8, further comprising determining, via the processor and based on the detected parameter signal, the first control barrier function, and the second control barrier function, whether the system is to operate in the second mode to cause the system to guarantee safety to the system.

11. The method of claim 8, further comprising:
determining, via the processor and based on the detected parameter signal, whether the system is to operate in the second mode,
wherein the detected parameter signal is based on at least one of a group of parameters comprising velocity of the system, acceleration of the system, distance of the system to a location, distance of the system to an object, a condition of an environment for which the system is disposed, and a parameter of the system.

12. The method of claim 8, further comprising:
determining, via the processor and based on the detected parameter signal, whether the system is to operate in the second mode,
wherein the detected parameter signal is based on a velocity of an autonomous vehicle.

13. The method of claim 12, further comprising determining, via the processor and based on the detected parameter signal, the first control barrier function, and the second control barrier function, whether the system is to operate in the second mode to cause the system to guarantee safety to an autonomous vehicle.

14. The method of claim 8, further comprising:
determining, via the processor and based on the detected parameter signal, whether the system is to operate in the second mode,
wherein the detected parameter signal is based on a condition of an environment for which an autonomous vehicle is disposed.

15. A non-transitory, computer-readable media having computer-readable instructions stored thereon, the computer-readable instructions being capable of being read by a mode switch controller, wherein the computer-readable instructions are capable of instructing the mode switch controller to perform the method comprising:
instructing, via a processor configured to execute the instructions stored in a memory, a hybrid mode controller to output the first mode control signal to cause a system to operate in a first mode;
instructing, via the processor and based on a detected parameter signal, a first control barrier function, and a second control barrier function, the hybrid mode controller to output a second mode control signal to cause the system to operate in a second mode,
wherein the first control barrier function is based on the system operating in the first mode and the system switching from operating in the first mode to operating in the second mode, and
wherein the second control barrier function is based on the system operating in the second mode.

16. The non-transitory, computer-readable media of claim 15, wherein the computer-readable instructions are capable of instructing the mode switch controller to perform the method wherein the second control barrier function is based on the system operating in the second mode and the system switching from operating in the first mode to operating in the second mode.

17. The non-transitory, computer-readable media claim 15, wherein the computer-readable instructions are capable of instructing the mode switch controller to perform the method further comprising determining, via the processor and based on the detected parameter signal, the first control barrier function, and the second control barrier function, whether the system is to operate in the second mode to cause the system to guarantee safety to the system.

18. The non-transitory, computer-readable media of claim 15, wherein the computer-readable instructions are capable of instructing the mode switch controller to perform the method further comprising:
determining, via the processor and based on the detected parameter signal, whether the system is to operate in the second mode,
wherein the detected parameter signal is based on at least one of a group of parameters comprising velocity of the system, acceleration of the system, distance of the system to a location, distance of the system to an object, a condition of an environment for which the system is disposed, and a parameter of the system.

19. The non-transitory, computer-readable media claim 15, wherein the computer-readable instructions are capable of instructing the mode switch controller to perform the method further comprising:
determining, via the processor and based on the detected parameter signal, whether the system is to operate in the second mode,
wherein the detected parameter signal is based on a velocity of an autonomous vehicle.

20. The non-transitory, computer-readable media claim 19, wherein the computer-readable instructions are capable of instructing the mode switch controller to perform the method further comprising determining, via the processor and based on the detected parameter signal, the first control barrier function, and the second control barrier function, whether the system is to operate in the second mode to cause the system to guarantee safety to an autonomous vehicle.
